(19) United States
(12) Patent Application Publication
(10) Pub. No.: US 2018/0044768 A1
(43) Pub. Date: Feb. 15, 2018

(54) FeNi ALLOY COMPOSITION COMPRISING L10-TYPE FeNi ORDERED PHASE, METHOD OF MANUFACTURING FeNi ALLOY COMPOSITION COMPRISING L10-TYPE FeNi ORDERED PHASE, FeNi ALLOY COMPOSITION COMPRISING AMORPHOUS MAIN PHASE, MOTHER ALLOY OF AMORPHOUS MATERIAL, AMORPHOUS MATERIAL, MAGNETIC MATERIAL, AND METHOD OF MANUFACTURING MAGNETIC MATERIAL

(71) Applicant: Tohoku University, Miyagi (JP)

(72) Inventor: Akihiro MAKINO, Miyagi (JP)

(73) Assignee: Tohoku University, Miyagi (JP)

(21) Appl. No.: 15/791,364

(22) Filed: Oct. 23, 2017

Related U.S. Application Data
(63) Continuation of application No. PCT/JP2016/062685, filed on Apr. 21, 2016.

(30) Foreign Application Priority Data
Apr. 23, 2015 (JP) 2015-088608

(51) Int. Cl. C22C 38/08; C22C 30/00; C22C 45/04; C22C 19/03; H01F 1/153; C22C 45/02

(52) U.S. Cl. CPC C22C 38/08; H01F 1/15308; C22C 45/02; C22C 45/04; C22C 19/03; C22C 30/00; C22F 1/10

(57) ABSTRACT

An FeNi alloy composition comprising an L1₀-type FeNi ordered phase is provided, which satisfies at least one of the conditions that the sum of the content of Fe and the content of Ni is 90 at. % or less and that the FeNi alloy composition contains Si, and preferably satisfies at least one of the conditions that the ratio of the content of Fe to the content of Ni is 0.3 or more and 5 or less and that the sum of the content of Fe and the content of Ni is 65 at. % or more.

### CROSS-REFERENCE TO RELATED APPLICATIONS

This application is a Continuation of PCT International Application No. PCT/JP2016/062685 filed on Apr. 21, 2016, which claims priority under 35 U.S.C §119(a) to Patent Application No. 2015-088608 filed in Japan on Apr. 23, 2015, all of which are hereby expressly incorporated by reference into the present application.

### TECHNICAL FIELD

The present invention relates to an FeNi alloy composition comprising an L1₀-type FeNi ordered phase, a method of manufacturing an FeNi alloy composition comprising an L1₀-type FeNi ordered phase, an FeNi alloy composition comprising an amorphous main phase and capable of generating an FeNi alloy composition comprising an L1₀-type FeNi ordered phase, a mother alloy of an amorphous material, an amorphous material obtained from the mother alloy, an FeNi alloy composition comprising an L1₀-type FeNi ordered phase obtained from the amorphous material, a magnetic material that contains the above FeNi alloy composition comprising an L1₀-type FeNi ordered phase, and a method of manufacturing the magnetic material.

### BACKGROUND ART

Iron meteorites having their Widmanstätten structure are alloys that are mainly composed of Fe and Ni. This structure is formed in space by being slowly cooled at an extremely moderate speed of about 0.3 K/10⁶ yr (Non-Patent Literature 1). The Widmanstätten structure found in octahedrite-type meteorites (octahedral iron meteorites) (iron meteorites) is unique and a small amount thereof is formed at the interface between an α-phase (bcc α-FeNi, mineral name: kamacite) and a γ-phase (fcc FeNi, mineral name: taenite) that are apparently separate phases. The lamellar taenite has varying Ni concentration zones (28% to 50%) (Non-Patent Literature 2). Both the disordered fcc phase and ordered L1₀ phase of Fe—Ni were detected. Interestingly, the L1₀ o-type FeNi ordered phase, also known as “tetrataenite,” is a hard magnetic substance that has high saturation magnetization (˜1,270 emu·cm⁻³) and large uniaxial magneto-crystalline anisotropy (˜1.3×10⁷ erg·cm⁻³) (Non-Patent Literature 3 to 5). The theoretical maximum energy product (˜42 MG·Oe) of the L1₀-type FeNi ordered phase exhibits a value that is comparable with the maximum value of a rare-earth-based hard magnet recently developed (Non-Patent Literature 3).

In consideration of the drawbacks of rare-earth elements used for manufacturing high-quality permanent magnets, it is important and necessary to develop rare-earth-free magnets, that is, to develop L1₀-type FeNi-based hard magnets. In practice, it is not possible to industrially manufacture L1₀-type FeNi ordered alloys in the same method as that for meteorites. This is because the ordered phase-disordered phase transformation temperature of the L1₀-type FeNi ordered phase is 320° C. (Non-Patent Literature 2, 3). The diffusion coefficients of Fe and Ni are considerably low around that temperature and diffusion does not actually take place. This is the reason why the generation of the L1₀-type FeNi ordered phase requires a long time of 10⁹ years as in the space-originated products (meteorites). Since the discovery of the L1₀-type FeNi ordered phase in the 1960s, various challenges have been tried to artificially produce that phase, such as irradiation with neutrons (Non-Patent Literature 6), microparticle methods (Non-Patent Literature 7), mechanical alloying (Non-Patent Literature 8), monatomic layers (Non-Patent Literature 9), and high-pressure straining processes (Non-Patent Literature 10).

As a specific example of such challenges, Patent Literature 1 discloses a production method for L1₀-type FeNi alloy particles. This method comprises: a step (1) for preparing a solution by dispersing and/or dissolving an Fe-containing compound, an Ni-containing compound, and a protective polymer in a solvent; a step (2) for preparing Fe- and Ni-containing precursor particles by adding, to the obtained solution, a reducer for Fe ions included in the Fe-containing compound and Ni ions included in the Ni-containing compound; and a step (3) for ordering the alloy particles to have an L1₀-type structure by heating the precursor particles under a hydrogen atmosphere and reducing the precursor particles. It is said that the above production method allows an L1₀-type FeNi alloy to be synthesized with a high degree of ordering.

Non-Patent Literature 10, 11 discloses a non-equilibrium process that utilizes nano-crystallization from an alloy as a starting material comprising an amorphous main phase. By employing such a process, it can be expected to generate a unique alloy phase that would not be achieved in alloys of an ordinary crystal system.

Patent Literature 2 describes a nanostructured magnetic alloy composition that comprises an alloy having the formula Fe_{(0.5-a)}Ni_{(0.5-b)}X_{(a+b)} (where X is Ti, V, Al, S, P, B, or C, and 0<(a+b)≦0.1), wherein the composition comprises L1₀ phase structure. Patent Literature 2 also describes a method for obtaining this composition. That is, the method comprises the steps of: preparing a melt comprising Fe, Ni, and one or more elements selected from the group consisting of Ti, V, Al, S, P, B, and C; cooling the melt by a melt spinning process, whereby the melt is converted into a solid form; mechanically milling the solid form, whereby the solid form is reduced to a plurality of nanoparticles; and compressing the nanoparticles to form a nanostructured magnetic alloy composition.

### PRIOR ART LITERATURE

### Patent Literature

[Patent Literature 1] WO2012/141205
[Patent Literature 2] US2014/0210581A

### Non-Patent Literature

[Non-Patent Literature 1] Goldstei.Ji & Short, J. M. “Cooling Rates of 27 Iron and Stony-Iron Meteorites.” Geochim Cosmochim Ac 31, p 1001-1023, doi:10.1016/0016-7037(67)90076-2 (1967)
[Non-Patent Literature 2] Albertsen, J. F., Knudsen, J. M., Roy-Poulsen, N. O. & Vistisen, L. “Meteorites and Thermodynamic Equilibrium in f.c.c. Iron-Nickel Alloys (25-50% Ni).” Phys Scripta 22, p 171-175, doi:10.1088/0031-8949/22/2/014 (1980)
[Non-Patent Literature 3] Lewis, L. H. et al. “De Magnete et Meteorite: Cosmically Motivated Materials.” Ieee Magn Lett 5, doi:10.1109/LMAG.2014.2312178 (2014)
[Non-Patent Literature 4] Pauleve, J., Chamberod, A., Krebs, K. & Bourret, A. “Magnetization Curves of Fe—Ni (50-50) Single Crystals Ordered by Neutron Irradiation with an Applied Magnetic Field.” J Appl Phys 39, p 989-990, doi:10.1063/1.1656361 (1968)
[Non-Patent Literature 5] Kojima, T. et al. “Addition of Co to L1₀-ordered FeNi films: influences on magnetic properties and ordered structures.” J Phys D Appl Phys 47, doi: 10.1088/0022-3727/47/42/425001 (2014)
[Non-Patent Literature 6] Neel, L., Dautreppe, D., Laugier, J., Pauleve, J. & Pauthenet, R. “Magnetic Properties of Iron-Nickel Single Crystal Ordered by Neutron Bombardment.” J Appl Phys 35, p 873-876, doi:10.1063/1.1713516 (1964)
[Non-Patent Literature 7] Yang, C. W., Williams, D. B. & Goldstein, J. I. “Low-temperature phase decomposition in metal from iron, stony-iron, and stony meteorites.” Geochim Cosmochim Ac 61, p 2943-2956, doi:10.1016/S0016-7037(97)00132-4 (1997)
[Non-Patent Literature 8] Geng, Y. et al. “Defect generation and analysis in mechanically alloyed stoichiometric Fe—Ni alloys.” J Alloys Compd 633, p 250-255, doi:10.1016/j.jallcom.2015.02.038 (2015)
[Non-Patent Literature 9] Shima, T., Okamura, M., Mitani, S. & Takanashi, K. “Structure and magnetic properties for L1₀-ordered FeNi films prepared by alternate monatomic layer deposition.” J Magn Magn Mater 310, p 2213-2214, doi:10.1016/j.jmmm.2006.10.799 (2007)
[Non-Patent Literature 10] Makino, A. “Nanocrystalline Soft Magnetic Fe—Si—B—P—Cu Alloys With High B of 1.8-1.9 T Contributable to Energy Saving.” IEEE Transactions on Magnetics 48, p 1331-1335, doi:10.1109/tmag.2011.2175210 (2012)
[Non-Patent Literature 11] Makino, A., He, M., Kubota, T., Yubuta, K. & Inoue, A. “New Excellent Soft Magnetic FeSiBPCu Nanocrystallized Alloys With High Bₛ of 1.9 T From Nanohetero-Amorphous Phase.” IEEE Transactions on Magnetics 45, p 4302-4305, doi: 10.1109/tmag.2009.2023862 (2009)

### DISCLOSURE OF THE INVENTION

### Problems to be Solved by the Invention

It appears to be very difficult or impossible to manufacture L1₀-type FeNi-based hard magnets by ordinary material synthesis utilizing atomic diffusion in a crystalline state. The biggest hurdles are the high stability of crystalline phases and the considerably low diffusivity of atoms around the order-disorder transition temperature. Successful generation of an L1₀-type FeNi ordered phase depends on the achievement of fast diffusion of atoms at low temperatures. Introduction of crystal defects by the high-pressure straining and the high-energy ball milling method played certain roles in improving the diffusivity of elements, but were not at necessary levels.

Patent Literature 2 fails to disclose examples. That is, Patent Literature 2 does not describe any experimental result that shows actual formation of a magnetic alloy composition comprising an L1₀ phase structure. Patent Literature 2 discloses a method of manufacturing a magnetic alloy composition, but nothing in Patent Literature 2 describes specific conditions and the like of individual steps that constitute the method. Patent Literature 2 explicitly describes that the maximum amount of elements represented by X should be 10 at. % or less in order to reduce the negative effect to the magnetic properties.

An object of the present invention is to provide an FeNi alloy composition comprising an L1₀-type FeNi ordered phase, from a different technical standpoint than the FeNi alloy composition as described in Patent Literature 2. Another object of the present invention is to provide a method of manufacturing an FeNi alloy composition comprising an L1₀-type FeNi ordered phase, using a non-equilibrium process that utilizes nano-crystallization from an alloy as a precursor comprising an amorphous main phase as disclosed in Non-Patent Literature 10, 11, an FeNi alloy composition comprising an amorphous main phase and capable of generating an FeNi alloy composition comprising an L1₀-type FeNi ordered phase, a mother alloy of an amorphous material, an amorphous material obtained from the mother alloy, an FeNi alloy composition comprising an L1₀-type FeNi ordered phase obtained from the amorphous material, a magnetic material that contains the above FeNi alloy composition comprising an L1₀-type FeNi ordered phase, and a method of manufacturing the magnetic material.

### Means for Solving the Problems

In the case of transformation from an amorphous state to a crystalline state, fast diffusion of atoms at low temperatures is possible. Distribution of elements in an amorphous alloy is similar to that in the big-bang beginning in which all the substances are in a liquid state. The liquid-like state of an amorphous alloy, however, can exist under room temperatures. The large difference when a stable crystalline state is reached from an amorphous state is a drastic increase in diffusivity at the transition temperature (i.e. crystallization temperature). This is contrary to cooling of a molten alloy. If an Fe₅₀Ni₅₀-based alloy is made in an amorphous state to have a crystallization temperature close to the order-disorder transition temperature, generation of an L1₀-type FeNi-based hard magnet may be highly possible.

Various Fe-based amorphous alloys have been developed until now. In general, unfortunately, the crystallization temperature of these alloys is a temperature above 450° C., which is much higher than the order-disorder transformation temperature of the L1₀-type FeNi ordered phase. In this context, the present inventors have developed a novel FeSiBPCu-based nanocrystalline soft magnetic alloy of a high magnetic flux density as described in Non-Patent Literature 10, 11. The initial state of the FeSiBPCu alloy is amorphous and crystallized into a-Fe in the remaining amorphous matrix phase at a lower temperature than 400° C. Crystallization of this amorphous alloy is very fast. That is, the atomic diffusion of the constituent elements is very fast. Moreover, this alloy contains phosphorus (P) as an element, as is present in the NWA6259 meteorite (Non-Patent Literature 3). These properties strongly promise the development of an L1₀-type FeNi-based hard magnet. Therefore, studies have been made using an alloy composition in which a part of Fe of the FeNiSiBPCu alloy is substituted with Ni. As a result, a novel knowledge has been obtained that an FeNi alloy composition comprising an L1₀-type FeNi ordered phase can be obtained.

Some aspects of the present invention accomplished based on the above knowledge are as follows.

(1) An FeNi alloy composition comprising an Llo-type FeNi ordered phase, characterized in that the sum of the content of Fe and the content of Ni is 90 at. % or less.

(2) The FeNi alloy composition comprising an L1₀-type FeNi ordered phase as described in the above (1), wherein the FeNi alloy composition contains an amorphization element.

(3) The FeNi alloy composition comprising an L1₀-type FeNi ordered phase as described in the above (2), wherein the amorphization element comprises one or more selected from the group consisting of Si, B, and P.

(4) The FeNi alloy composition comprising an L1₀-type FeNi ordered phase as described in the above (2) or (3), wherein the sum of the content of the amorphization element is 35 at. % or less.

(5) The FeNi alloy composition comprising an L1₀-type FeNi ordered phase as described in the above (2) or (3), wherein the sum of the content of the amorphization element is 25 at. % or less.

(6) The FeNi alloy composition comprising an L1₀-type FeNi ordered phase as described in the above (2) or (3), wherein the sum of the content of the amorphization element is 20 at. % or less.

(7) An FeNi alloy composition comprising an L1₀-type FeNi ordered phase, characterized in that the FeNi alloy composition contains Si.

(8) The FeNi alloy composition comprising an L1₀-type FeNi ordered phase as described in the above (7), wherein the content of Si is 0.5 at. % or more.

(9) The FeNi alloy composition comprising an L1₀-type FeNi ordered phase as described in the above (7) or (8), wherein the content of Si is 20 at. % or less.

(10) The FeNi alloy composition comprising an L1₀-type FeNi ordered phase as described in any one of the above (7) to (9), wherein the sum of the content of Fe and the content of Ni is 90 at. % or less.

(11) The FeNi alloy composition comprising an L1₀-type FeNi ordered phase as described in any one of the above (7) to (10), wherein the FeNi alloy composition further contains an amorphization element other than Si.

(12) The FeNi alloy composition comprising an L1₀-type FeNi ordered phase as described in the above (11), wherein the amorphization element comprises at least one of B and P.

(13) The FeNi alloy composition comprising an L1₀-type FeNi ordered phase as described in the above (11) or (12), wherein the sum of the content of the amorphization element is 35 at. % or less.

(14) The FeNi alloy composition comprising an L1₀-type FeNi ordered phase as described in the above (11) or (12), wherein the sum of the content of the amorphization element is 25 at. % or less.

(15) The FeNi alloy composition comprising an L1₀-type FeNi ordered phase as described in the above (11) or (12), wherein the sum of the content of the amorphization element is 20 at. % or less.

(16) The FeNi alloy composition comprising an L1₀-type FeNi ordered phase as described in any one of the above (1) to (15), wherein the ratio of the content of Fe to the content of Ni is 0.3 or more and 5 or less.

(17) The FeNi alloy composition comprising an L1₀-type FeNi ordered phase as described in any one of the above (1) to (16), wherein the ratio of the content of Fe to the content of Ni is 0.6 or more and 1.5 or less.

(18) The FeNi alloy composition comprising an L1₀-type FeNi ordered phase as described in any one of the above (1) to (17), wherein the sum of the content of Fe and the content of Ni is 65 at. % or more.

(19) The FeNi alloy composition comprising an L1₀-type FeNi ordered phase as described in any one of the above (1) to (18), wherein the FeNi alloy composition further comprises a crystallization element.

(20) The FeNi alloy composition comprising an L1₀-type FeNi ordered phase as described in any one of the above (1) to (19), wherein the FeNi alloy composition further contains one or more selected from the group consisting of Cu, Co, Ti, Zr, Hf, V, Nb, Ta, Cr, Mo, W, Mn, Re, platinum group elements, Au, Ag, Zn, In, Sn, As, Sb, Bi, S, Y, N, O, C, and rare-earth elements.

(21) The FeNi alloy composition comprising an L1₀-type FeNi ordered phase as described in any one of the above (1) to (20), wherein the FeNi alloy composition is free from a component originated from a meteorite.

(22) The FeNi alloy composition comprising an L1₀-type FeNi ordered phase as described in any one of the above (1) to (21), wherein the FeNi alloy composition has a part of which a long-range order (LRO) parameter S is 0.65 or more, wherein the LRO parameter S is calculated based on a measurement result when a nano-beam electron diffraction (NBD) pattern of the L1₀-type FeNi ordered phase is measured.

(23) The FeNi alloy composition comprising an L1₀-type FeNi ordered phase as described in the above (22), wherein the FeNi alloy composition has a part of which the parameter S is 0.75 or more.

(24) The FeNi alloy composition comprising an L1₀-type FeNi ordered phase as described in any one of the above (1) to (23), wherein the FeNi alloy composition has remanent coercivity Hcr of 1×10⁵ A/m or more.

(25) The FeNi alloy composition comprising an L1₀-type FeNi ordered phase as described in any one of the above (1) to (24), wherein the L1₀-type FeNi ordered phase included in the FeNi alloy composition has an ordered phase-disordered phase transformation temperature of 450° C. or higher and 600° C. or lower.

(26) The FeNi alloy composition comprising an L1₀-type FeNi ordered phase as described in any one of the above (1) to (25), wherein the FeNi alloy composition contains a-Fe.

(27) The FeNi alloy composition comprising an L1₀-type FeNi ordered phase as described in any one of the above (1) to (26), wherein the FeNi alloy composition contains an Fe rich phase and a Ni rich phase.

(28) A method of manufacturing an FeNi alloy composition comprising an L1₀-type FeNi ordered phase, the method being characterized by comprising: a solidification step of rapidly melt-quenching an alloy melt to produce a solid comprising an amorphous main phase, the alloy melt comprising Fe and Ni; and a heat treatment step of heating and crystallizing the solid comprising an amorphous main phase to form an FeNi alloy composition comprising an L1₀-type FeNi ordered phase, the solid comprising an amorphous main phase being obtained through the solidification step.

(29) The method of manufacturing an FeNi alloy composition comprising an L1₀-type FeNi ordered phase as described in the above (28), wherein the solid comprising an amorphous main phase obtained through the solidification step has a crystallization temperature of 300° C. or higher and 550° C. or lower.

(30) The method of manufacturing an FeNi alloy composition comprising an L1₀-type FeNi ordered phase as described in the above (29), wherein the crystallization temperature is 300° C. or higher and 500° C. or lower.

(31) The method of manufacturing an FeNi alloy composition comprising an L1₀-type FeNi ordered phase as described in any one of the above (28) to (30), wherein a heating temperature in the heat treatment step is 300° C. or higher and 550° C. or lower.

(32) The method of manufacturing an FeNi alloy composition comprising an L1₀-type FeNi ordered phase as described in the above (31), wherein the heating temperature is 300° C. or higher and 500° C. or lower.

(33) The method of manufacturing an FeNi alloy composition comprising an L1₀-type FeNi ordered phase as described in any one of the above (28) to (32), wherein a heating temperature in the heat treatment step is equal to or higher than a crystallization temperature of the solid comprising an amorphous main phase.

(34) The method of manufacturing an FeNi alloy composition comprising an L1₀-type FeNi ordered phase as described in any one of the above (28) to (33), wherein a heating temperature in the heat treatment step is equal to or lower than an ordered phase-disordered phase transformation temperature of the L1₀-type FeNi ordered phase included in the FeNi alloy composition.

(35) The method of manufacturing an FeNi alloy composition comprising an L1₀-type FeNi ordered phase as described in any one of the above (28) to (34), wherein the composition of a mother alloy giving the alloy melt comprising Fe and Ni comprises a composition of the FeNi alloy composition comprising an L1₀-type FeNi ordered phase as described in any one of the above (1) to (21).

(36) An FeNi alloy composition comprising an amorphous main phase and capable of generating an FeNi alloy composition comprising an L1₀-type FeNi ordered phase, the FeNi alloy composition being characterized by comprising a composition of the FeNi alloy composition comprising an L1₀-type FeNi ordered phase as described in any one of the above (1) to (21).

(37) The FeNi alloy composition comprising an amorphous main phase as described in the above (36), wherein the FeNi alloy composition has a crystallization temperature of 300° C. or higher and 550° C. or lower.

(38) The FeNi alloy composition comprising an amorphous main phase as described in the above (36), wherein the FeNi alloy composition has a crystallization temperature of 300° C. or higher and 500° C. or lower.

(39) A mother alloy of an amorphous material, comprising a composition of the FeNi alloy composition comprising an L1₀-type FeNi ordered phase as described in any one of the above (1) to (21). As used in the present description, the “amorphous material” refers to a solid that comprises an amorphous main phase formed from an alloy melt. Specific examples of a method of formation include a rapid melt quenching method.

(40) An amorphous material obtained from the mother alloy as described in the above (39).

(41) An FeNi alloy composition comprising an L1₀-type FeNi ordered phase, the FeNi alloy composition being obtained from the amorphous material as described in the above (40).

(42) A magnetic material containing the FeNi alloy composition comprising an L1₀-type FeNi ordered phase as described in any one of the above (1) to (27) and (41).

(43) A method of manufacturing a magnetic material containing an FeNi alloy composition comprising an L1₀-type FeNi ordered phase, the FeNi alloy composition being manufactured through the method of manufacturing as described in any one of the above (28) to (35).

(44) A magnetic material containing an FeNi alloy composition comprising an L1₀-type FeNi ordered phase, the FeNi alloy composition being obtained from the FeNi alloy composition comprising an amorphous main phase as described in any one of the above (36) to (38).

In the present description, measurement of thermophysical parameters of the FeNi alloy composition, such as an ordered phase-disordered phase transformation temperature and crystallization temperature, refers to a value that is measured when the FeNi alloy composition is heated at a rate of temperature rise of 40° C./min.

### Effect of the Invention

According to the present invention, there is provided an FeNi alloy composition comprising an L1₀-type FeNi ordered phase. In addition, according to the present invention, there are provided a method of manufacturing an FeNi alloy composition comprising an L1₀-type FeNi ordered phase, an FeNi alloy composition comprising an amorphous main phase and capable of generating an FeNi alloy composition comprising an L1₀-type FeNi ordered phase, a mother alloy of an amorphous material, an amorphous material obtained from the mother alloy, an FeNi alloy composition comprising an L1₀-type FeNi ordered phase obtained from the amorphous material, a magnetic material that contains the above FeNi alloy composition comprising an L1₀-type FeNi ordered phase, and a method of manufacturing the magnetic material.

### BRIEF DESCRIPTION OF DRAWINGS

FIG. 1 is a view showing an X-ray diffraction pattern of the FeNi alloy composition comprising an L1₀-type FeNi ordered phase manufactured in Example 1 and an X-ray diffraction pattern obtained by calculation.

FIG. 2 is a set of views showing results of structure observation and electron diffraction image observation using a microscope and results of calculation for the FeNi alloy composition comprising an L1₀-type FeNi ordered phase manufactured in Example 1.

FIG. 3 is a view showing a magnetic hysteresis curve and dc demagnetization remanence curve of the FeNi alloy composition comprising an L1₀-type FeNi ordered phase manufactured in Example 1 and magnetic force microscopy images.

FIG. 4 is a set of views showing results of structure observation using a microscope for the FeNi alloy composition comprising an L1₀-type FeNi ordered phase manufactured in Example 14-4.

FIG. 5 is a view showing a result of structure observation using a microscope for the FeNi alloy composition comprising an L1₀-type FeNi ordered phase manufactured in Example 15-3.

### BEST MODE(S) FOR CARRYING OUT THE INVENTION

Embodiments of the present invention will be hereinafter described in detail.

### (FeNi Alloy Composition Comprising L1₀-Type FeNi Ordered Phase)

The FeNi alloy composition comprising an L1₀-type FeNi ordered phase according to an embodiment of the present invention is manufactured through a method of manufacturing in which an alloy melt comprising Fe and Ni is rapidly melt-quenched to produce a solid comprising an amorphous main phase and the obtained solid comprising an amorphous main phase is crystallized. In the present description, the phrase “comprising an amorphous main phase,” or “the main phase being an amorphous,” means that a phase of which the volume fraction is highest is amorphous in a material as an object (such as a solid obtained through rapidly melt-quenching an alloy melt comprising Fe and Ni).

In a nonlimiting example, the crystallization temperature of the above solid comprising an amorphous main phase is 300° C. or higher and 550° C. or lower and the heating temperature for crystallizing the above solid comprising an amorphous main phase is 300° C. or higher and 550° C. or lower. It may be preferred that the crystallization temperature of the above solid comprising an amorphous main phase be 300° C. or higher and 500° C. or lower and the heating temperature for crystallizing the above solid comprising an amorphous main phase be 300° C. or higher and 500° C. or lower. When the crystallization temperature is low, the FeNi alloy composition comprising an L1₀-type FeNi ordered phase can be obtained at high productivity. The above crystallization temperature may more preferably be 300° C. or higher and 400° C. or lower

In the FeNi alloy composition comprising an L1₀-type FeNi ordered phase, the sum of the content of Fe and the content of Ni is preferably 65 at. % or more and 90 at. % or less. When the sum of the content of Fe and the content of Ni is within the above range, the content of the L1₀-type FeNi ordered phase in the FeNi alloy composition readily increases. The sum of the content of Fe and the content of Ni may be less than 90 at. % or may also be 88 at. % or less, 87 at. % or less, 86 at. % or less, 85.5 at. % or less, 85 at. % or less, 84.5 at. % or less, 84 at. % or less, 83.5 at. % or less, or 83 at. % or less. The sum of the content of Fe and the content of Ni may more preferably be 70 at. % or more and 85 at. % or less.

In the FeNi alloy composition comprising an L1₀-type FeNi ordered phase, the ratio of the content of Fe to the content of Ni is preferably 0.6 or more and 1.5 or less. When the ratio of the content of Fe to the content of Ni is within the above range, the content of the L1₀-type FeNi ordered phase in the FeNi alloy composition readily increases. In this regard, the ratio of the content of Fe to the content of Ni may more preferably be 0.8 or more and 1.2 or less. In the FeNi alloy composition comprising an L1₀-type FeNi ordered phase, in view of allowing the L1₀-type FeNi ordered phase to be included therein, the ratio of the content of Fe to the content of Ni may preferably be 0.3 or more, may more preferably be 0.35 or more, and may further preferably be 0.4 or more. In the FeNi alloy composition comprising an L1₀-type FeNi ordered phase, in view of allowing the L1₀-type FeNi ordered phase to be included therein, the ratio of the content of Fe to the content of Ni may preferably be 5 or less, may more preferably be 4.6 or less, and may further preferably be 4 or less.

The FeNi alloy composition comprising an L1₀-type FeNi ordered phase may contain an amorphization element such as Si, P and B. The amorphization element is an element that contributes to amorphization of the solid main phase which is positioned as a precursor for forming the FeNi alloy composition comprising an L1₀-type FeNi ordered phase. The sum of the content of the amorphization element is not limited. The sum of the content of the amorphization element may preferably be 20 at. % or less, may more preferably be 18 at. % or less, and may further preferably be 16 at. % or less. The sum of the content of the amorphization element being excessively large may be associated with deterioration of the magnetic properties of the FeNi alloy composition comprising an L1₀-type FeNi ordered phase, but there is a case where the FeNi alloy composition in which the sum of the content of the amorphization element is 25 at. % or less (i.e., the upper limit of the above sum is 25 at. %) has excellent magnetic properties and there is also a case where the FeNi alloy composition in which the sum of the content of the amorphization element is 35 at. % or less (i.e., the upper limit of the above sum is 35 at. %) has excellent magnetic properties.

The FeNi alloy composition comprising an L1₀-type FeNi ordered phase may contain a crystallization element such as Cu. The crystallization element is an element that contributes to crystallizing the solid comprising an amorphous main phase to form the FeNi alloy composition comprising an L1₀-type FeNi ordered phase. The FeNi alloy composition comprising an L1₀-type FeNi ordered phase may contain both the amorphization element and the crystallization element. The content of the crystallization element is not limited. The content of the crystallization element may preferably be 5 at. % or less, may more preferably be 2 at. % or less, and may further preferably be 1 at. % or less.

The FeNi alloy composition comprising an L1₀-type FeNi ordered phase according to an embodiment of the present invention may contain, as elements other than the above elements, one or more arbitrary additive elements X selected from the group consisting of Co, Ti, Zr, Hf, V, Nb, Ta, Cr, Mo, W, Mn, Re, platinum group elements, Au, Ag, Zn, In, Sn, As, Sb, Bi, S, Y, N, O, C, and rare-earth elements. The above arbitrary additive elements X include elements that can serve similar functions to those of Fe and Ni, amorphization elements similar to Si, B, P and the like, and crystallization elements similar to Cu. The arbitrary additive elements X may be contained to substitute for a part of Fe and/or Ni in accordance with the functions. When the FeNi alloy composition comprising an L1₀-type FeNi ordered phase contains amorphization elements and/or crystallization elements, the arbitrary elements may be contained to substitute for a part of them. The additive amount of the arbitrary additive elements X is appropriately set in accordance with the functions which the arbitrary additive elements X serve.

The FeNi alloy composition comprising an L1₀-type FeNi ordered phase according to an embodiment of the present invention may contain incidental impurities in addition to components based on the above elements. The FeNi alloy composition comprising an L1₀-type FeNi ordered phase according to an embodiment of the present invention may preferably be free from components originated from meteorites in view of ensuring supply stability as industrial products.

The FeNi alloy composition comprising an L1₀-type FeNi ordered phase may contain α-Fe. Whether the α-Fe is contained can be confirmed from the X-ray diffraction pattern of the FeNi alloy composition comprising an L1₀-type FeNi ordered phase. The α-Fe is considered to be generated by crystallization of the solid comprising an amorphous main phase which is positioned as a precursor for forming the FeNi alloy composition comprising an L1₀-type FeNi ordered phase.

When a nano-beam electron diffraction (NBD) pattern of the L1₀-type FeNi ordered phase included in the FeNi alloy composition according to an embodiment of the present invention is measured, the FeNi alloy composition may preferably include a part of which a long-range order (LRO) parameter S is 0.65 or more, may more preferably include a part of which the LRO parameter S is 0.70 or more, and may particularly preferably include a part of which the LRO parameter S is 0.75 or more.

The FeNi alloy composition comprising an L1₀-type FeNi ordered phase according to an embodiment of the present invention may preferably have remanent coercivity Hcr of 1×10⁵ A/m (100 kA/m) or more. In the FeNi alloy composition comprising an L1₀-type FeNi ordered phase according to an embodiment of the present invention, the ordered phase-disordered phase transformation temperature of the L1₀-type FeNi ordered phase may be 450° C. or higher and 600° C. or lower. In such a case, if heated to a temperature within this temperature range or higher, the L1₀-type FeNi ordered phase contained in the FeNi alloy composition transforms to a disordered phase and the FeNi alloy composition will be a composition that substantially does not include an L1₀-type FeNi ordered phase. The remanent coercivity Hcr in this state is about 8×10⁴ A/m. In an embodiment of the present invention, therefore, the remanent coercivity Hcr of the FeNi alloy composition comprising an L1₀-type FeNi ordered phase being 1×10⁵ A/m or more means that the FeNi alloy composition according to an embodiment of the present invention includes an appropriate amount of the L1₀-type FeNi ordered phase to an extent that the magnetic properties derived from the L1₀-type FeNi ordered phase are stably actualized. The remanent coercivity Hcr of the FeNi alloy composition comprising an L1₀-type FeNi ordered phase according to an embodiment of the present invention may more preferably be 1.1×10⁵ A/m or more, may further preferably be 1.2×10⁵ A/m or more, may particularly preferably be 1.3×10⁵ A/m or more, and may remarkably preferably be 1.4×10⁵ A/m or more.

The FeNi alloy composition comprising an L1₀-type FeNi ordered phase may contain an Fe rich phase and a Ni rich phase. The Fe rich phase and the Ni rich phase can be confirmed by using an energy dispersive spectrometer (EDS) provided together with an electron microscope, or the like. The Fe rich phase is a phase that is measured to contain a larger amount of Fe than that in other phases and may possibly contain α-Fe. When the FeNi alloy composition comprising an L1₀-type FeNi ordered phase contains B as the amorphization element, the Fe rich phase may possibly contain B. The Ni rich phase is a phase that is measured to contain a larger amount of Ni than that in other phases. When the FeNi alloy composition comprising an L1₀-type FeNi ordered phase contains Si and/or P as the amorphization elements, the Ni rich phase may contain Si and/or P. The L1₀-type FeNi ordered phase may exist between the Fe rich phase and the Ni rich phase.

### (Method of Manufacturing FeNi Alloy Composition Comprising L1₀-Type FeNi Ordered Phase)

The above FeNi alloy composition comprising an L1₀-type FeNi ordered phase according to an embodiment of the present invention can be manufactured through a method of manufacturing that comprises a solidification step and a heat treatment step, which will be described below.

### (1) Solidification Step

First, in the solidification step, an alloy melt comprising Fe and Ni is rapidly melt-quenched to produce a solid comprising an amorphous main phase (amorphous material). The method of rapid melt-quenching is not limited. Examples of the method include a rapid quenching method for thin strips, such as a single-roll method and double-roll method, an atomization method, such as a gas-atomization method and water-atomization method. In view of easily increasing the cooling speed and easily enhancing the level of a non-equilibrium process, the amorphous material may preferably be manufactured through the rapid quenching method for thin strips.

As previously described, in order that the solid comprising an amorphous main phase can be readily obtained, the mother alloy giving the alloy melt comprising Fe and Ni (such a mother alloy will be referred simply to as a “mother alloy,” hereinafter) may preferably contain an amorphization element such as Si, P and B, as previously described, and may more preferably contain one or more elements selected from the group consisting of Si, P and B. Other examples of the amorphization element include C.

When Si is added to the mother alloy, the solid comprising an amorphous main phase can readily be obtained. If the additive amount of Si in the mother alloy is unduly large, it is highly possible that the L1₀-type FeNi ordered phase contained in the FeNi alloy composition decreases. In view of achieving easy acquisition of the solid comprising an amorphous main phase and also easy acquisition of the FeNi alloy composition in which the L1₀-type FeNi ordered phase is appropriately contained, the additive amount of Si when Si is added to the mother alloy may preferably be 0.5 at. % or more and 10 at. % or less and may more preferably be 2 at. % or more and 8 at. % or less. The additive amount of Si being excessively large may be associated with deterioration of the magnetic properties of the FeNi alloy composition comprising an L1₀-type FeNi ordered phase, but there is a case where the FeNi alloy composition in which the content of Si is 20 at. % or less has excellent magnetic properties. As will be understood, in an ordinary method of manufacturing, the additive amount of elements added to obtain the mother alloy is substantially equal to the content of the elements in the alloy melt obtained from the mother alloy and is also substantially equal to the content of the elements in the FeNi alloy composition formed from the alloy melt. In the present description, therefore, the additive amount of elements to the mother alloy and the content of the elements in the composition (composition comprising an amorphous main phase or composition containing an L1₀-type FeNi ordered phase) obtained from the mother alloy are meant to be substantially equal amounts.

When B is added to the mother alloy, the solid comprising an amorphous main phase can readily be obtained. If the additive amount of B in the mother alloy is unduly large, the range of heat treat conditions for generating the FeNi alloy composition comprising an Llo-type FeNi ordered phase from the solid comprising an amorphous main phase may tend to be narrow. In view of achieving easy acquisition of the solid comprising an amorphous main phase and also easy acquisition of the FeNi alloy composition in which the L1₀-type FeNi ordered phase is appropriately contained, the additive amount of B when B is added to the mother alloy may preferably be 2 at. % or more and 15 at. % or less, may more preferably be 4 at. % or more and 12 at. % or less, and may further preferably be 4 at. % or more and 10 at. % or less. The additive amount of B being excessively large may be associated with deterioration of the magnetic properties of the FeNi alloy composition comprising an L1₀-type FeNi ordered phase, but there is a case where the FeNi alloy composition in which the content of B is 20 at. % or less has excellent magnetic properties.

When P is added to the mother alloy, the solid comprising an amorphous main phase can readily be obtained. If the additive amount of P in the mother alloy is unduly large, it is highly possible that the L1₀-type FeNi ordered phase contained in the FeNi alloy composition decreases. In view of achieving easy acquisition of the solid comprising an amorphous main phase and also easy acquisition of the FeNi alloy composition in which the L1₀-type FeNi ordered phase is appropriately contained, the additive amount of P when P is added to the mother alloy may preferably be 2 at. % or more and 8 at. % or less and may more preferably be 3 at. % or more and 6 at. % or less. The additive amount of P being excessively large may be associated with deterioration of the magnetic properties of the FeNi alloy composition comprising an L1₀-type FeNi ordered phase, but there is a case where the FeNi alloy composition in which the content of P is 20 at. % or less has excellent magnetic properties.

### (2) Heat Treatment Step

In the heat treatment step, the solid comprising an amorphous main phase obtained through the above solidification step is heated and crystallized to form the FeNi alloy composition comprising an L1₀-type FeNi ordered phase. The heating condition is appropriately set in accordance with the nature of the solid comprising an amorphous main phase. The heating temperature in the heat treatment step is preferably higher than the crystallization temperature of the above solid comprising an amorphous main phase because it is crystallized by heating.

In an example, the crystallization temperature of the above solid comprising an amorphous main phase is 300° C. or higher and 550° C. or lower. In this case, the heating temperature in the heat treatment step may be 300° C. or higher and 550° C. or lower. In a preferred example, the crystallization temperature of the above solid comprising an amorphous main phase is 300° C. or higher and 500° C. or lower. In this case, the heating temperature in the heat treatment step may be 300° C. or higher and 500° C. or lower. In a further preferred example, the crystallization temperature of the above solid comprising an amorphous main phase is 300° C. or higher and 400° C. or lower. In this case, the heating temperature in the heat treatment step may be 300° C. or higher and 400° C. or lower. The heating time is appropriately set in accordance with the heating temperature. The basic tendency is that, the higher the heating temperature is, the shorter the heating time is set, while the lower the heating temperature is, the longer the heating time is set. In a nonlimiting example, the heating time is selected from a range of 30 minutes or longer and 300 hours or shorter. Surprisingly, the FeNi alloy composition comprising an L1₀-type FeNi ordered phase is formed by heating for about 300 hours with consideration that, as previously described, formation of the FeNi alloy composition comprising an L1₀-type FeNi ordered phase requires a long time of about 10 billion years in the natural world. Such reduction in time required for generating the L1₀-type FeNi ordered phase is also supported by simulation using a molecular dynamics method. That is, calculation results are obtained that the self-diffusion coefficients of Fe and Ni exhibit higher values in an amorphous phase than those in an equilibrium crystalline phase by two-digit or more.

In view of making it easy to crystallize the above solid comprising an amorphous main phase in the heat treatment step, the mother alloy preferably contains a crystallization element such as Cu.

A specific example when using Cu will be described. When Cu is added to the mother alloy, crystallization of the solid comprising an amorphous main phase readily progresses in the heat treatment step. If the additive amount of Cu in the alloy melt comprising Fe and Ni is unduly large, it is highly possible that the alloy comprising an amorphous main phase is difficult to be obtained even when the alloy melt comprising Fe and Ni is rapidly quenched and it is also highly possible that the homogeneity of the obtained alloy comprising an amorphous main phase deteriorates. In view of achieving easy crystallization of the solid comprising an amorphous main phase and also easy acquisition of the solid comprising an amorphous main phase, the additive amount of Cu when Cu is added to the mother alloy may preferably be 0.1 at. % or more and 3 at. % or less, may more preferably be 0.2 at. % or more and 1.5 at. % or less, and may further preferably be 0.4 at. % or more and 1.0 at. % or less.

In accordance with the composition of the FeNi alloy composition comprising an L1₀-type FeNi ordered phase according to an embodiment of the present invention, the sum of the content of Fe and the content of Ni in the alloy melt comprising Fe and Ni may be 65 at. % or more and 90 at. % or less, and the ratio of the content of Fe to the content of Ni in the alloy melt comprising Fe and Ni may be 0.6 or more and 1.5 or less.

Examples of the mother alloy include, but are not limited to, FeNi-based alloys that have a composition of Fe₄₂Ni_{41.3}SiₓB₁₂₋ₓP₄Cu_{0.7}(numerical values denote at. % and x is 2 or more and 8 or less, here and hereinafter). Among the above FeNi-based alloys, the case of x=8, that is, Fe₄₂Ni_{41.3}Si₈B₄P₄Cu_{0.7} readily generates an L1₀-type FeNi ordered phase. As will be understood, in the case of using a binary alloy of FeNi, it is very difficult to realize the industrial production of an L1₀-type FeNi ordered phase even when the composition is varied and/or the method of manufacturing is adjusted.

### (FeNi Alloy Composition Comprising Amorphous Main Phase)

The FeNi alloy composition comprising an amorphous main phase according to an embodiment of the present invention is capable of generating the FeNi alloy composition comprising an L1₀-type FeNi ordered phase, has the sum of the content of Fe and the content of Ni is 65 at. % or more and 90 at. % or less, and contains an amorphization element and a crystallization element. The method of manufacturing such an FeNi alloy composition comprising an amorphous main phase is not limited. When the above solidification step included in the method of manufacturing the FeNi alloy composition comprising an L1₀-type FeNi ordered phase is carried out, the solid comprising an amorphous main phase obtained as a product in that step can represent the above FeNi alloy composition comprising an amorphous main phase.

The crystallization temperature of the FeNi alloy composition comprising an amorphous main phase is preferably 300° C. or higher and 500° C. or lower and more preferably 300° C. or higher and 400° C. or lower.

### (Magnetic Material)

A material that contains the FeNi alloy composition comprising an L1₀-type FeNi ordered phase according to an embodiment of the present invention can be suitably used as a magnetic material. Moreover, a material that contains the FeNi alloy composition comprising an L1₀-type FeNi ordered phase and manufactured through the method of manufacturing an FeNi alloy composition comprising an L1₀-type FeNi ordered phase according to an embodiment of the present invention can also be suitably used as a magnetic material. Furthermore, a material that contains the FeNi alloy composition comprising an L1₀-type FeNi ordered phase and generated from the FeNi alloy composition comprising an amorphous main phase according to an embodiment of the present invention can also be suitably used as a magnetic material.

The embodiments heretofore explained are described to facilitate understanding of the present invention and are not described to limit the present invention. Therefore, it is intended that the elements disclosed in the above embodiments include all design changes and equivalents to fall within the technical scope of the present invention.

### EXAMPLES

Hereinafter, the present invention will be further specifically described with reference to examples, etc., but the scope of the present invention is not limited to these examples, etc.

### Example 1

Mother alloys of Fe₄₂Ni_{41.3}SiₓB₁₂₋ₓP₄Cu_{0.7} were produced through high-frequency melting and ribbon-like samples (ribbon materials) were obtained by a single-roll rapid melt-quenching method in the air. The heat treatment was performed while enclosing the ribbon-like samples in silica tubes filled with argon gas. These tubes were subjected to heat treatment in a heat-treatment furnace preheated to a predetermined heat-treatment temperature and FeNi alloy compositions were thus obtained.

Among the mother alloys of Fe₄₂Ni_{41.3}SiₓB₁₂₋ₓP₄Cu_{0.7}, those of which the Si concentration was high, that is, in which x was large tended to allow easy acquisition of amorphous phases. The main phase of a ribbon material comprising an alloy of Fe₄₂Ni_{41.3}Si₈B₄P₄Cu_{0.7} in the case of x=8 among the above mother alloys was amorphous, and the crystallization temperature measured using a differential scanning calorimeter was 400° C. (rate of temperature rise of 40° C./min). The ribbon material comprising an amorphous main phase was crystallized through heat treatment at 400° C. for 288 hours.

The structure of the ribbon material after crystallization was identified using an X-ray diffractometer (“SmartLab” available from Rigaku Corporation). Fitting of the experimentally-obtained XRD curve was performed using commercially-available software (“CrystalMaker” available from HULINKS Inc).

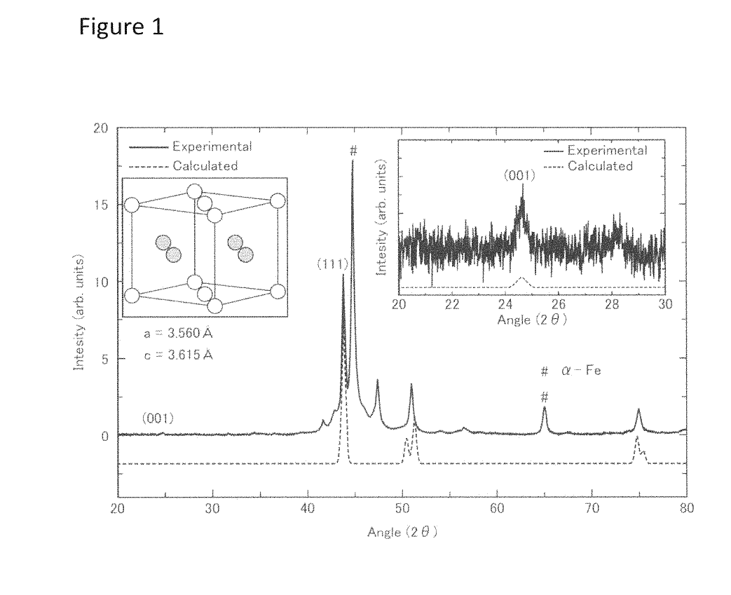

FIG. 1 shows X-ray diffraction patterns of the ribbon material after crystallization. FIG. 1 is a view showing an X-ray diffraction pattern (solid lines) of the FeNi alloy composition comprising an L1₀-type FeNi ordered phase manufactured in the present example and an X-ray diffraction pattern (broken lines) obtained by calculation. Right inset is an enlarged view of the range in which 20 of (001) diffraction ranges from 20° to 30°. Left inset demonstrates the atomic arrangement of an L1₀-type FeNi ordered phase depicted with Fe atoms (blank circles) and Ni atoms (filled circles) in which the lattice parameters are a=3.560 Å and c=3.615 Å.

As shown in FIG. 1, diffraction peaks corresponding to an L1₀-type FeNi ordered phase (inset of FIG. 1) were detected along with those of α-Fe and some unknown phases. The XRD pattern obtained in this experiment was fitted with the L1₀-type FeNi ordered phase. The lattice parameters of the L1₀-type FeNi ordered phase, a and c, were 3.560 Å and 3.615 Å, respectively, and these results were very close to those of a natural meteorite (3.582 Å and 3.607 Å). The intensity of superlattice diffraction was very weak because the X-ray scattering factors of Fe and Ni are close to each other. The calculated intensity of (001) superlattice reflection was 0.3% of that from the (111) fundamental plane and this result was much lower than a value (˜1.7%) experimentally observed heretofore. This suggests the existence of a texture in the normal direction to the plane of the ribbon material.

A sample for electron microscope observation was obtained by performing an ion milling process in an argon atmosphere for a part of the ribbon material after crystallization. The microstructure of the sample was observed using a transmission electron microscope (“JEM-ARM200F” available from JEOL Ltd.) in a scanning transmission electron microscopy (STEM) mode at an acceleration voltage of 200 kV. This apparatus is equipped with a cold cathode-type field emission gun and an irradiation system aberration corrector (Cs corrector). Nano-beam electron diffraction (NBD) patterns were observed by scanning the sample plane with a convergent electron beam of a size of about 0.1 nm (convergence semi-angle of 4 mrad). Composition analysis was conducted using an energy dispersive spectrometer (EDS) equipped together with the STEM. The sample thickness was estimated by electron energy loss spectroscopy (EELS) in the STEM mode.

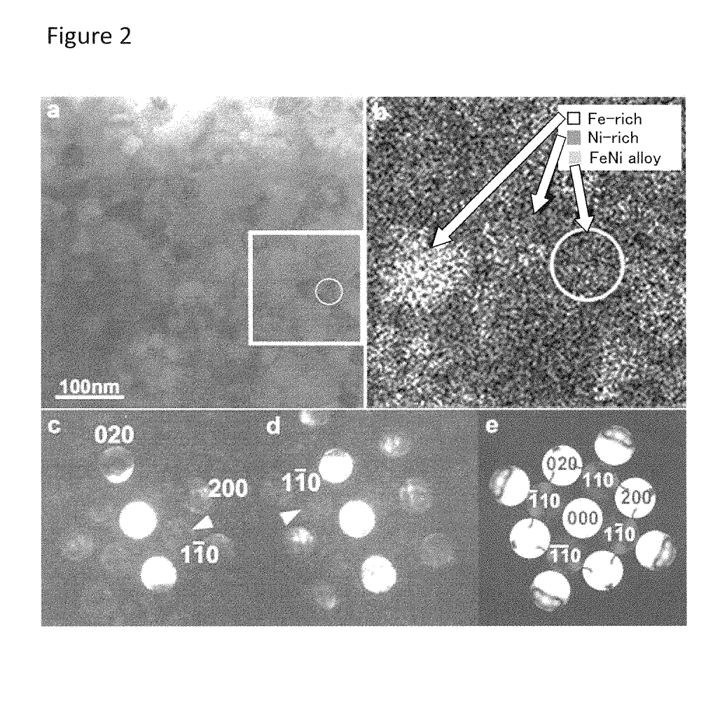

FIG. 2a shows a STEM-bright-field image after annealing the alloy of Fe₄₂Ni_{41.3}Si₈B₄P₄Cu_{0.7} at 400° C. for 288 hours. FIG. 2 is a set of views showing results of structure observation and electron diffraction image observation using a scanning transmission electron microscope (STEM) and results of calculation for the FeNi alloy composition comprising an L1₀-type FeNi ordered phase manufactured in the present example. FIG. 2a is a STEM-bright-field image. FIG. 2b is STEM-EDX element mapping, in which the light color part represents an Fe rich phase, the dark color part represents a Ni rich phase, the intermediate color part represents an alloy part of Fe and Ni, and the L1₀-type FeNi ordered phase appears to be included in the alloy part. FIG. 2c and FIG. 2d are nano-beam electron diffraction (NBD) patterns obtained from the circled areas in FIG. 2a and FIG. 2b, respectively. FIG. 2e is a calculated NBD pattern of an L1₀-type ordered structure of which the long-range order (LRO) parameter S is 0.8.

As shown in FIG. 2a, it has been confirmed that the structure is composed of polycrystalline grains having a grain diameter of 30 to 50 nm. The result of the STEM-EDX element mapping has revealed that the microstructure is composed of, as shown in FIG. 2b, at least three phases: an Fe rich phase, a Ni rich phase, and an approximately equiatomic Fe—Ni alloy phase. During the observation, Si and P were detected in the Ni rich phase and were not detected from any of the Fe rich phase and the Fe—Ni alloy phase. Such a solute concentration distribution, therefore, represents an Fe rich phase that corresponds to α-Fe as detected from the X-ray measurement (FIG. 1). It is possible that the unknown diffraction peaks of XRD represent a Ni silicide/phosphide phase.

Nano-beam diffraction (NBD) patterns of superlattice reflection were obtained from a certain area of the Fe—Ni alloy phase. FIGS. 2c and 2d are nano-beam electron diffraction (NBD) patterns of [001] incidence obtained from the circled areas in FIGS. 2a and 2b. Four-folded symmetric 110 ordered lattice diffraction is clearly observed. This indicates formation of an L1₀-type ordered structure in which the c-axis is oriented perpendicularly to the ribbon sample surface. This result is consistent with the XRD measurement. The estimated long-range order (LRO) parameter S is about 0.8 or more, which was evaluated by simulating the NBD patterns as a function of LRO parameters. This value is 0.65 or more, which is larger than the value of a natural meteorite (S=0.608). It is highly possible that the natural meteorite surface is exposed to a high temperature when entering the Earth's atmosphere thereby to reduce the parameter S.

FIG. 2e shows an NBD pattern of an L1₀-type ordered structure with S=0.8. Ordered lattice diffraction is denoted by white characters. In the case of a polycrystalline body, the frequency of observing ordered lattice reflections is low. This is because the intensity of the ordered lattice reflection is sensitively deteriorated due to misorientation from the zone axis. Therefore, the distribution of the degree of order cannot be experimentally observed. If the parameter S is 0.75 or less, the intensity of ordered lattice reflections is too weak for them to be actually observed. Regardless of the above-described restrictions, the single crystal electron diffraction patterns were successfully detected as shown in FIGS. 2c and 2d. This is a strong experimental evidence for formation of the L1₀-type FeNi ordered phase. Thus, the NBD has revealed the formation of an L1₀-type FeNi ordered phase that is highly ordered in the rapidly quenched nanocrystalline thin strip.

The saturation magnetization (Ms) and the coercivity (Hc) and direct-current demagnetization remanence (Md) curves were measured using a vibrating sample magnetometer (VSM). To measure the direct-current demagnetization remanence (Md) in the perpendicular direction to the sample plane, the ribbon sample was subjected to a positive magnetic field of 10,000 Oe, which was applied in the perpendicular direction to the ribbon plane. The magnetic field was made to zero to record the remanence magnetization. Thereafter, a small negative magnetic field was applied and then returned to zero to measure the remanent magnetization. Similar steps were repeated while increasing the negative magnetic field to obtain the Md—H curve.

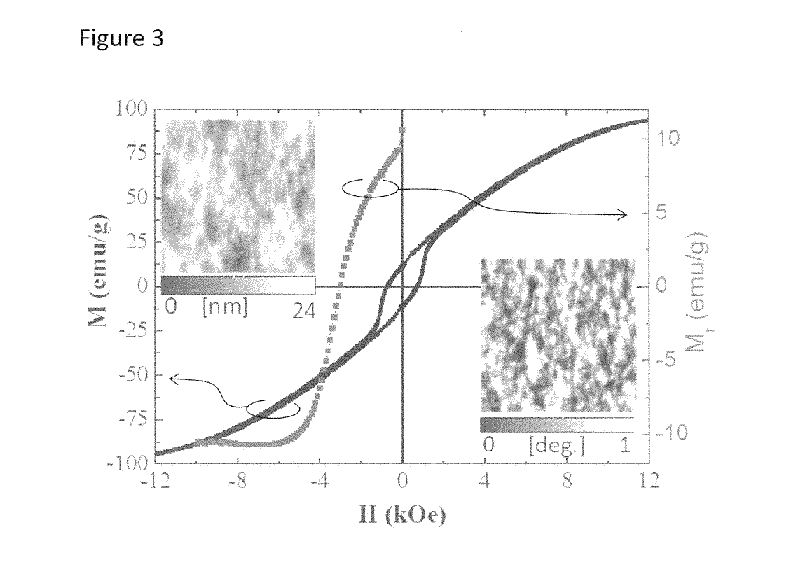

FIG. 3 shows a magnetic hysteresis curve (left-side vertical scale) obtained when measured by applying a maximum magnetic field of 12,000 Oe perpendicularly to the surface of the sample comprising a ribbon material (ribbon sample). FIG. 3 is obtained through measurement by applying a maximum magnetic field of about 12,000 Oe perpendicularly to the ribbon sample plane. Insets of FIG. 3 are magnetic force microscopy images showing the magnetic domains. The dc demagnetization remanence curve (right-side vertical scale) illustrated in FIG. 3 shows that at least about 3.5 kOe is required for the magnetization reversal of crystal grains comprising L1₀-type FeNi ordered phases.

The saturation magnetization (Ms) and the coercivity were about 100 emu/g (saturation magnetization (Ms) when estimated using a density of 8.367 g·cm⁻³ of equiatomic Fe₅₀Ni₅₀ alloy obtained from the arithmetically averaged density of pure metal Fe and Ni is about 836.7 g·cm⁻³) and 700 Oe, respectively.

The rapid increase in the magnetization at lower magnetic fields and the linear variation at higher magnetic fields suggest the following two processes:

(1) alignment of the out-of-plane magnetization due to the domain wall motion at the lower magnetic fields; and

(2) rotation of the in-plane magnetization to the normal direction to the plane at the higher magnetic fields.

The latter process can be easily understood based on the presence of soft magnetic phases (Fe rich phase and Ni rich phase) that have magnetization easy axes in the ribbon plane. The magnetization easy axis of the L1₀-type FeNi ordered phase is along the c-axis, which is perpendicular to the ribbon surface (due to the texture). It appears that the alignment of the out-of-plane magnetization at the lower magnetic fields is caused by the presence of crystal grains comprising hard magnetic L1₀-type FeNi ordered phases. In the absence of a magnetic field, the magnetization tends to remain along the magnetization easy axes, that is, to remain in the normal direction to the L1₀-type FeNi ordered phase plane and in the plane of the soft magnetic phase. Therefore, the remanent magnetization (Mr) in FIG. 3 is almost due to crystal grains comprising L1₀-type FeNi ordered phases, but the higher the volume fraction of the soft magnetic phase is, the lower the coercivity of the sample is, because the coercivity in the normal direction to the plane is strongly affected by the rotation of the in-plane magnetization.

The magnetic reversal of the L1₀-type FeNi ordered phase can be understood from the direct current demagnetization remanence (Md) curve (FIG. 3). Basically, the Md is magnetization that remains when the reversed magnetic field is applied to the initially saturated crystal grains comprising L1₀-type FeNi ordered phases. FIG. 3 shows that at least about 3.5 kOe is required for the magnetization reversal of crystal grains comprising L1₀-type FeNi ordered phases present in the ribbon sample. Ordering in other directions [such as in (111)] of crystal grains comprising L1₀-type FeNi ordered phases allows the magnetic reversal to take place at lower reversed magnetic fields. It is thus considered that the magnetic field for magnetic reversal of the crystal grains comprising L1₀-type FeNi ordered phases is higher than 3.5 kOe. Such a high reversing magnetic field is consistent with the nature of high magnetic anisotropy of the L1₀-type FeNi ordered phase. Magnetic domain images were also obtained using a magnetic force microscope (MFM). Insets of FIG. 3 show typical MFM images along the surface profile. To eliminate effects of the surface profile in the MFM images, the distance between the tip and the sample surface was varied from 25 nm to 100 nm. In all cases, MFM images provide the same features, which show that the contrast of the images is mainly caused by the interaction between the magnetic tip and the magnetism of the sample in the normal direction to its plane. Magnetic domains of the sample (insets of FIG. 3) are similar to those of other hard magnetic nano-composite magnets comprising both the soft and hard magnetic phases. It is believed that, according to both the structural and magnetic characterizations as the above, the generation of an artificial L1₀-type FeNi ordered phase has been confirmed.

The following contents can be understood from the above example.

Chemically ordered hard magnetic L1₀-type FeNi ordered phases of higher quality than natural meteorites have been artificially produced. That is, the FeNi alloy composition comprising an L1₀-type FeNi ordered phase manufactured according to the present example is free from components originated from meteorites. The solid comprising an amorphous main phase obtained through rapidly melt-quenching an alloy of FeNiSiBPCu is crystallized thereby to be able to shorten the time for formation of L1₀-type FeNi ordered phases to 300 hours, which has been estimated to require hundreds of millions of years.

The artificial L1₀-type FeNi ordered phase included in the FeNi alloy composition according to the present invention exhibits clear 110 superlattice diffraction, which has not yet been observed, and has high magnetization reversal due to an applied magnetic field of at least 3.5 kOe. The artificial L1₀-type FeNi ordered phase included in the FeNi alloy composition according to the present invention has an estimated ordering degree parameter (S≧0.8) and this value is the highest among the ordering degree parameters of an L1₀-type FeNi ordered phase contained in natural meteorites, of an L1₀-type FeNi ordered phase in other artificially manufactured compositions, and of an L1₀-type FeNi ordered phase included in laminated films produced through a special method.

The reason that the artificial L1₀-type FeNi ordered phase is generated in a short time through crystallization of a rapidly melt-quenched non-equilibrium amorphous phase appears to be due to simultaneously satisfying the following three factors;

(Factor 1) fast diffusion of the constituent elements in the amorphous phase;

(Factor 2) a large driving force when the L1₀-type FeNi ordered phase precipitates from the amorphous phase; and

(Factor 3) presence of clusters containing L1₀-type FeNi ordered phases in the heterogeneous amorphous phase.

### Example 2 to Example 24

Mother alloys of compositions as listed in Table 1 to Table 16 were prepared. The mother alloys were produced through high-frequency melting and ribbon-like samples (ribbon materials) were obtained by a single-roll rapid melt-quenching method in the air. The heat treatment was performed while enclosing the ribbon-like samples in silica tubes filled with argon gas. These tubes were subjected to heat treatment in a heat-treatment furnace preheated to a predetermined heat-treatment temperature and FeNi alloy compositions were thus obtained. In Table 1, “Fe/Ni” is the ratio of the content (at. %) of Fe to the content (at. %) of Ni in the mother alloy. This ratio is substantially equal to the ratio of the content (at. %) of Fe to the content (at. %) of Ni in the FeNi alloy composition after heat treatment. The “magnetic element ratio” is the ratio of the content (at. %) of magnetic elements (specifically Fe and Ni) in the mother alloy to the mother alloy as a whole. This ratio is substantially equal to the ratio of the content (at. %) of magnetic elements (specifically Fe and Ni) in the FeNi alloy composition after heat treatment to the FeNi alloy composition as a whole. As will be understood, the ribbon material (FeNi alloy composition) after heat treatment according to Example 16-3 is equal to the ribbon material crystallized through heat treatment at 400° C. for 288 hours using a mother alloy of Fe₄₂Ni_{41.3}SiₓB₁₂₋ₓP₄Cu_{0.7}, which has been evaluated in detail in Example 1.

The structures of the ribbon materials (FeNi alloy compositions) before and after heat treatment were identified using an X-ray diffractometer (“SmartLab” available from Rigaku Corporation). The results are listed in Table 1 to Table 16. Results of the X-ray diffraction are indicated in the following manner. When the measurement object is determined to be in an amorphous state, indication is “A.” When some peak or peaks are recognized but substantially non-identifiable and the measurement object is determined to be approximately in an amorphous state, indication is “AA.” The indication “AM” in the results of X-ray diffraction refers to a case where the measurement object is determined to be in a state in which fine crystals precipitate while the measurement object comprises an amorphous main phase. The indication “AC” in the results of X-ray diffraction refers to a case where the measurement object is determined to be in a state in which an amorphous phase and a crystallized phase are present in a mixture. When, in a ribbon material after heat treatment, a peak (peak α) located at an angle (2θ) of about 45° and thus attributable to α-Fe and a peak (peak L1₀) located at an angle (2θ) of about 24° and thus attributable to the L1₀-type FeNi ordered phase are recognized, the ratio of the intensity of peak L1₀ to the intensity of peak α is indicated. The case of this ratio being “0” means that the intensity of peak L1₀ was not calculable because the peak L1₀ was recognized but the intensity was low relative to the noise level. The indication “-” in the results of X-ray diffraction means that measurement was not conducted.

The coercivity He and remanent coercivity Hcr of ribbon materials after heat treatment were measured. Measurement results are listed in Table 1 to Table 16. Measurement of the coercivity Hc was performed using a vibrating sample-type magnetometer (“PV-M10-5” available from Toei Scientific Industrial Co., Ltd.) and the vibration frequency in the measurement was 80 Hz. Measurement of the remanent coercivity Hcr was performed using the vibrating sample-type magnetometer (“PV-M10-5” available from Toei Scientific Industrial Co., Ltd.) and the vibration frequency in the measurement was 1.7 kHz. The unit of measurement results is the cgs-Gauss unit system (Oe) based on the functionality of the measurement equipment and therefore the results corresponding to the SI unit system (A/m) are also listed. There are cases where the remanent coercivity Hcr is not measured and in such cases indication in the tables is “-.” Also in other measurement items, the indication “-” means that measurement was not conducted.

TABLE 1

| | | | | | | | | | | Result of |
|---|---|---|---|---|---|---|---|---|---|---|
| | | | | | | | | | Mag- | X-ray |
| | | | | | | | | | netic | diffraction |
| | | | | | | | | | ele- | (before |
| | Composition (at. %) | | | | | | | | ment | heat |
| | Fe | Ni | Si | B | P | Cu | C | Fe/Ni | ratio | treatment) |
| Example | 57 | 19 | 9 | 10 | 5 | Not | Not | 3 | 76 | A |
| 2-1 | | | | | | added | added | | | |
| Example | 57 | 19 | 9 | 10 | 5 | Not | Not | 3 | 76 | A |
| 2-2 | | | | | | added | added | | | |
| Example | 57 | 19 | 9 | 10 | 5 | Not | Not | 3 | 76 | A |
| 2-3 | | | | | | added | added | | | |
| Example | 57 | 19 | 9 | 10 | 5 | Not | Not | 3 | 76 | A |
| 2-4 | | | | | | added | added | | | |
| Example | 38 | 38 | 9 | 10 | 5 | Not | Not | 1 | 76 | A |
| 3-1 | | | | | | added | added | | | |
| Example | 38 | 38 | 9 | 10 | 5 | Not | Not | 1 | 76 | A |
| 3-2 | | | | | | added | added | | | |
| Example | 38 | 38 | 9 | 10 | 5 | Not | Not | 1 | 76 | A |
| 3-3 | | | | | | added | added | | | |
| Example | 38 | 38 | 9 | 10 | 5 | Not | Not | 1 | 76 | A |
| 3-4 | | | | | | added | added | | | |
| Example | 38 | 38 | 9 | 10 | 5 | Not | Not | 1 | 76 | A |
| 3-5 | | | | | | added | added | | | |
| Example | 38 | 38 | 9 | 10 | 5 | Not | Not | 1 | 76 | A |
| 3-6 | | | | | | added | added | | | |
| Example | 38 | 38 | 9 | 10 | 5 | Not | Not | 1 | 76 | A |
| 3-7 | | | | | | added | added | | | |
| Example | 38 | 38 | 9 | 10 | 5 | Not | Not | 1 | 76 | A |
| 3-8 | | | | | | added | added | | | |
| Example | 38 | 38 | 9 | 10 | 5 | Not | Not | 1 | 76 | A |
| 3-9 | | | | | | added | added | | | |

TABLE 2

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 400 | 24 | A | 3.2 | 0.3 | — | — | Example |
| 2-1 | | | | | | | | of the |
| | | | | | | | | invention |
| Example | 450 | 24 | 0 | 263 | 21 | — | — | Example |
| 2-2 | | | | | | | | of the |
| | | | | | | | | invention |
| Example | 520 | 1 | 0 | 306 | 24 | — | — | Example |
| 2-3 | | | | | | | | of the |
| | | | | | | | | invention |
| Example | 540 | 0.5 | 0 | 487 | 39 | — | — | Example |
| 2-4 | | | | | | | | of the |
| | | | | | | | | invention |
| Example | 400 | 24 | AA | 10 | 0.8 | — | — | Example |
| 3-1 | | | | | | | | of the |
| | | | | | | | | invention |
| Example | 450 | 24 | 0 | 481 | 38 | — | — | Example |
| 3-2 | | | | | | | | of the |
| | | | | | | | | invention |
| Example | 450 | 120 | 0 | 635 | 51 | 2383 | 190 | Example |
| 3-3 | | | | | | | | of the |
| | | | | | | | | invention |
| Example | 450 | 336 | 0.04 | 706 | 56 | 2165 | 172 | Example |
| 3-4 | | | | | | | | of the |
| | | | | | | | | invention |
| Example | 450 | 480 | 0.03 | 651 | 52 | — | — | Example |
| 3-5 | | | | | | | | of the |
| | | | | | | | | invention |
| Example | 450 | 1488 | 0.04 | 696 | 55 | — | — | Example |
| 3-6 | | | | | | | | of the |
| | | | | | | | | invention |
| Example | 520 | 1 | 0 | 449 | 36 | — | — | Example |
| 3-7 | | | | | | | | of the |
| | | | | | | | | invention |
| Example | 520 | 1.5 | 0 | 239 | 19 | — | — | Example |
| 3-8 | | | | | | | | of the |
| | | | | | | | | invention |
| Example | 540 | 0.17 | 0.01 | 622 | 49 | 2532 | 201 | Example |
| 3-9 | | | | | | | | of the |
| | | | | | | | | invention |

TABLE 3

| | | | | | | | | | | Result of |
|---|---|---|---|---|---|---|---|---|---|---|
| | | | | | | | | | Mag- | X-ray |
| | | | | | | | | | netic | diffraction |
| | | | | | | | | | ele- | (before |
| | Composition (at. %) | | | | | | | Fe/ | ment | heat |
| | Fe | Ni | Si | B | P | Cu | C | Ni | ratio | treatment) |
| Example | 38 | 38 | 14 | 10 | Not | Not | Not | 1 | 76 | A |
| 4-1 | | | | | added | added | added | | | |
| Example | 38 | 38 | 14 | 10 | Not | Not | Not | 1 | 76 | A |
| 4-2 | | | | | added | added | added | | | |
| Example | 38 | 38 | 14 | 10 | Not | Not | Not | 1 | 76 | A |
| 4-3 | | | | | added | added | added | | | |
| Example | 38 | 38 | 14 | 10 | Not | Not | Not | 1 | 76 | A |
| 4-4 | | | | | added | added | added | | | |
| Example | 38 | 38 | 14 | 10 | Not | Not | Not | 1 | 76 | A |
| 4-5 | | | | | added | added | added | | | |
| Example | 38 | 38 | 14 | 10 | Not | Not | Not | 1 | 76 | A |
| 4-6 | | | | | added | added | added | | | |
| Example | 38 | 38 | 16 | 8 | Not | Not | Not | 1 | 76 | A |
| 5-1 | | | | | added | added | added | | | |
| Example | 38 | 38 | 16 | 8 | Not | Not | Not | 1 | 76 | A |
| 5-2 | | | | | added | added | added | | | |
| Example | 38 | 38 | 18 | 6 | Not | Not | Not | 1 | 76 | A |
| 6-1 | | | | | added | added | added | | | |
| Example | 38 | 38 | 18 | 6 | Not | Not | Not | 1 | 76 | A |
| 6-2 | | | | | added | added | added | | | |
| Example | 38 | 38 | 20 | 4 | Not | Not | Not | 1 | 76 | AM |
| 7-1 | | | | | added | added | added | | | |
| Example | 38 | 38 | 20 | 4 | Not | Not | Not | 1 | 76 | A |
| 7-2 | | | | | added | added | added | | | |

TABLE 4

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 520 | 1 | 0 | 619 | 49 | 2058 | 164 | Example |
| 4-1 | | | | | | | | of the |
| | | | | | | | | invention |
| Example | 520 | 24 | — | 368 | 29 | 1854 | 148 | Example |
| 4-2 | | | | | | | | of the |
| | | | | | | | | invention |
| Example | 520 | 120 | — | 310 | 25 | 1854 | 148 | Example |
| 4-3 | | | | | | | | of the |
| | | | | | | | | invention |
| Example | 520 | 216 | — | 268 | 21 | 1856 | 148 | Example |
| 4-4 | | | | | | | | of the |
| | | | | | | | | invention |
| Example | 520 | 720 | — | 182 | 14 | 1652 | 131 | Example |
| 4-5 | | | | | | | | of the |
| | | | | | | | | invention |
| Example | 540 | 1 | 0.03 | 506 | 40 | 2056 | 164 | Example |
| 4-6 | | | | | | | | of the |
| | | | | | | | | invention |
| Example | 520 | 1 | 0.02 | 751 | 60 | 1856 | 148 | Example |
| 5-1 | | | | | | | | of the |
| | | | | | | | | invention |
| Example | 540 | 1 | 0.05 | 635 | 51 | 1856 | 148 | Example |
| 5-2 | | | | | | | | of the |
| | | | | | | | | invention |
| Example | 520 | 1 | 0.03 | 621 | 49 | — | — | Example |
| 6-1 | | | | | | | | of the |
| | | | | | | | | invention |
| Example | 540 | 1 | 0.03 | 483 | 38 | 1856 | 148 | Example |
| 6-2 | | | | | | | | of the |
| | | | | | | | | invention |
| Example | 520 | 1 | 0.03 | 641 | 51 | — | — | Example |
| 7-1 | | | | | | | | of the |
| | | | | | | | | invention |
| Example | 540 | 1 | 0.04 | 565 | 45 | 1654 | 132 | Example |
| 7-2 | | | | | | | | of the |
| | | | | | | | | invention |

TABLE 5

| | | | | | | | | | | Result |
|---|---|---|---|---|---|---|---|---|---|---|
| | | | | | | | | | | of |
| | | | | | | | | | | X-ray |
| | | | | | | | | | | diffrac- |
| | | | | | | | | | | tion |
| | | | | | | | | | Mag- | (before |
| | | | | | | | | | netic | heat |
| | Composition (at. %) | | | | | | | Fe/ | element | treat- |
| | Fe | Ni | Si | B | P | Cu | C | Ni | ratio | ment) |
| Example | 78.3 | 5 | 4 | 8 | 4 | 0.7 | Not | 15.7 | 83.3 | A |
| 8-1 | | | | | | | added | | | |
| Example | 73.3 | 10 | 4 | 8 | 4 | 0.7 | Not | 7.33 | 83.3 | A |
| 9-1 | | | | | | | added | | | |
| Example | 68.3 | 15 | 4 | 8 | 4 | 0.7 | Not | 4.55 | 83.3 | A |
| 10-1 | | | | | | | added | | | |
| Example | 68.3 | 15 | 4 | 8 | 4 | 0.7 | Not | 4.55 | 83.3 | A |
| 10-2 | | | | | | | added | | | |
| Example | 68.3 | 15 | 4 | 8 | 4 | 0.7 | Not | 4.55 | 83.3 | A |
| 10-3 | | | | | | | added | | | |
| Example | 68.3 | 15 | 4 | 8 | 4 | 0.7 | Not | 4.55 | 83.3 | A |
| 10-4 | | | | | | | added | | | |
| Example | 68.3 | 15 | 4 | 8 | 4 | 0.7 | Not | 4.55 | 83.3 | A |
| 10-5 | | | | | | | added | | | |
| Example | 68.3 | 15 | 4 | 8 | 4 | 0.7 | Not | 4.55 | 83.3 | A |
| 10-6 | | | | | | | added | | | |
| Example | 68.3 | 15 | 4 | 8 | 4 | 0.7 | Not | 4.55 | 83.3 | A |
| 10-7 | | | | | | | added | | | |
| Example | 63.3 | 20 | 4 | 8 | 4 | 0.7 | Not | 3.17 | 83.3 | AM |
| 11-1 | | | | | | | added | | | |

TABLE 6

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 300 | 24 | 0 | 5 | 0.4 | — | — | Example |
| 8-1 | | | | | | | | of the |
| | | | | | | | | invention |
| Example | 300 | 24 | 0 | 4.2 | 0.3 | — | — | Example |
| 9-1 | | | | | | | | of the |
| | | | | | | | | invention |
| Example | 400 | 24 | 0 | 2.5 | 0.2 | 2205 | 175 | Example |
| 10-1 | | | | | | | | of the |
| | | | | | | | | invention |
| Example | 450 | 24 | 0.01 | 19 | 2 | — | — | Example |
| 10-2 | | | | | | | | of the |
| | | | | | | | | invention |
| Example | 480 | 1 | 0 | 792 | 63 | — | — | Example |
| 10-3 | | | | | | | | of the |
| | | | | | | | | invention |
| Example | 500 | 1 | 0 | 355 | 28 | — | — | Example |
| 10-4 | | | | | | | | of the |
| | | | | | | | | invention |
| Example | 520 | 1 | 0 | 367 | 29 | — | — | Example |
| 10-5 | | | | | | | | of the |
| | | | | | | | | invention |
| Example | 540 | 1 | 0 | 403 | 32 | — | — | Example |
| 10-6 | | | | | | | | of the |
| | | | | | | | | invention |
| Example | 560 | 1 | 0 | 465 | 37 | — | — | Example |
| 10-7 | | | | | | | | of the |
| | | | | | | | | invention |
| Example | 300 | 24 | 0 | 8 | 0.6 | — | — | Example |
| 11-1 | | | | | | | | of the |
| | | | | | | | | invention |

TABLE 7

| | | | | | | | | | | Result |
|---|---|---|---|---|---|---|---|---|---|---|
| | | | | | | | | | | of |
| | | | | | | | | | | X-ray |
| | | | | | | | | | | diffrac- |
| | | | | | | | | | | tion |
| | | | | | | | | | Mag- | (before |
| | | | | | | | | | netic | heat |
| | Composition (at. %) | | | | | | | Fe/ | element | treat- |
| | Fe | Ni | Si | B | P | Cu | C | Ni | ratio | ment) |
| Example | 42 | 41.3 | 4 | 8 | 4 | 0.7 | Not | 1.02 | 83.3 | A |
| 12-1 | | | | | | | added | | | |
| Example | 42 | 41.3 | 4 | 8 | 4 | 0.7 | Not | 1.02 | 83.3 | A |
| 12-2 | | | | | | | added | | | |
| Example | 42 | 41.3 | 4 | 8 | 4 | 0.7 | Not | 1.02 | 83.3 | A |
| 12-3 | | | | | | | added | | | |
| Example | 42 | 41.3 | 4 | 8 | 4 | 0.7 | Not | 1.02 | 83.3 | A |
| 12-4 | | | | | | | added | | | |
| Example | 42 | 41.3 | 4 | 8 | 4 | 0.7 | Not | 1.02 | 83.3 | A |
| 12-5 | | | | | | | added | | | |
| Example | 42 | 41.3 | 4 | 8 | 4 | 0.7 | Not | 1.02 | 83.3 | A |
| 12-6 | | | | | | | added | | | |
| Example | 42 | 41.3 | 4 | 8 | 4 | 0.7 | Not | 1.02 | 83.3 | A |
| 12-7 | | | | | | | added | | | |
| Example | 42 | 41.3 | 4 | 8 | 4 | 0.7 | Not | 1.02 | 83.3 | A |
| 12-8 | | | | | | | added | | | |
| Example | 42 | 41.3 | 4 | 8 | 4 | 0.7 | Not | 1.02 | 83.3 | A |
| 12-9 | | | | | | | added | | | |
| Example | 42 | 41.3 | 4 | 8 | 4 | 0.7 | Not | 1.02 | 83.3 | A |
| 12-10 | | | | | | | added | | | |
| Example | 23.3 | 60 | 4 | 8 | 4 | 0.7 | Not | 0.39 | 83.3 | AM |
| 13-1 | | | | | | | added | | | |
| Example | 13.3 | 70 | 4 | 8 | 4 | 0.7 | Not | 0.19 | 83.3 | AM |
| 14-1 | | | | | | | added | | | |

TABLE 8

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 300 | 24 | 0 | 3.8 | 0.3 | — | — | Example |
| 12-1 | | | | | | | | of the |
| | | | | | | | | invention |
| Example | 400 | 24 | 0.03 | 456 | 36 | — | — | Example |
| 12-2 | | | | | | | | of the |
| | | | | | | | | invention |
| Example | 450 | 24 | 0.02 | 525 | 42 | — | — | Example |
| 12-3 | | | | | | | | of the |
| | | | | | | | | invention |
| Example | 500 | 0.17 | 0 | 140 | 11 | — | — | Example |
| 12-4 | | | | | | | | of the |
| | | | | | | | | invention |
| Example | 520 | 1 | 0.03 | 501 | 40 | — | — | Example |
| 12-5 | | | | | | | | of the |
| | | | | | | | | invention |
| Example | 540 | 0.5 | — | 586 | 47 | 1280 | 102 | Example |
| 12-6 | | | | | | | | of the |
| | | | | | | | | invention |
| Example | 540 | 1 | 0.02 | 202 | 16 | — | — | Example |
| 12-7 | | | | | | | | of the |
| | | | | | | | | invention |
| Example | 560 | 1 | 0.02 | 437 | 35 | — | — | Example |
| 12-8 | | | | | | | | of the |
| | | | | | | | | invention |
| Example | 580 | 0.17 | 0.02 | 354 | 28 | — | — | Example |
| 12-9 | | | | | | | | of the |
| | | | | | | | | invention |
| Example | 600 | 0.17 | 0.02 | 287 | 23 | — | — | Example |
| 12-10 | | | | | | | | of the |
| | | | | | | | | invention |
| Example | 500 | 1 | 0 | 492 | 39 | 1885 | 150 | Example |
| 13-1 | | | | | | | | of the |
| | | | | | | | | invention |
| Example | 500 | 1 | 0 | 281 | 22 | — | — | Example |
| 14-1 | | | | | | | | of the |
| | | | | | | | | invention |

TABLE 9

| | | | | | | | | | | Result |
|---|---|---|---|---|---|---|---|---|---|---|
| | | | | | | | | | | of |
| | | | | | | | | | | X-ray |
| | | | | | | | | | | diffrac- |
| | | | | | | | | | | tion |
| | | | | | | | | | Mag- | (before |
| | | | | | | | | | netic | heat |
| | Composition (at. %) | | | | | | | Fe/ | element | treat- |
| | Fe | Ni | Si | B | P | Cu | C | Ni | ratio | ment) |
| Example | 42 | 41.3 | Not | 12 | 4 | 0.7 | Not | 1.02 | 83.3 | A |
| 12-1 | | | added | | | | added | | | |
| Example | 42 | 41.3 | Not | 12 | 4 | 0.7 | Not | 1.02 | 83.3 | A |
| 12-2 | | | added | | | | added | | | |
| Example | 42 | 41.3 | Not | 12 | 4 | 0.7 | Not | 1.02 | 83.3 | A |
| 12-3 | | | added | | | | added | | | |
| Example | 42 | 41.3 | 2 | 10 | 4 | 0.7 | Not | 1.02 | 83.3 | A |
| 13-1 | | | | | | | added | | | |
| Example | 42 | 41.3 | 2 | 10 | 4 | 0.7 | Not | 1.02 | 83.3 | A |
| 13-2 | | | | | | | added | | | |
| Example | 42 | 41.3 | 2 | 10 | 4 | 0.7 | Not | 1.02 | 83.3 | A |
| 13-3 | | | | | | | added | | | |
| Example | 42 | 41.3 | 4 | 8 | 4 | 0.7 | Not | 1.02 | 83.3 | A |
| 14-1 | | | | | | | added | | | |
| Example | 42 | 41.3 | 4 | 8 | 4 | 0.7 | Not | 1.02 | 83.3 | A |
| 14-2 | | | | | | | added | | | |
| Example | 42 | 41.3 | 4 | 8 | 4 | 0.7 | Not | 1.02 | 83.3 | A |
| 14-3 | | | | | | | added | | | |
| Example | 42 | 41.3 | 4 | 8 | 4 | 0.7 | Not | 1.02 | 83.3 | A |
| 14-4 | | | | | | | added | | | |
| Example | 42 | 41.3 | 6 | 6 | 4 | 0.7 | Not | 1.02 | 83.3 | A |
| 15-1 | | | | | | | added | | | |
| Example | 42 | 41.3 | 6 | 6 | 4 | 0.7 | Not | 1.02 | 83.3 | A |
| 15-2 | | | | | | | added | | | |
| Example | 42 | 41.3 | 6 | 6 | 4 | 0.7 | Not | 1.02 | 83.3 | A |
| 15-3 | | | | | | | added | | | |
| Example | 42 | 41.3 | 8 | 4 | 4 | 0.7 | Not | 1.02 | 83.3 | A |
| 16-1 | | | | | | | added | | | |
| Example | 42 | 41.3 | 8 | 4 | 4 | 0.7 | Not | 1.02 | 83.3 | A |
| 16-2 | | | | | | | added | | | |
| Example | 42 | 41.3 | 8 | 4 | 4 | 0.7 | Not | 1.02 | 83.3 | A |
| 16-3 | | | | | | | added | | | |
| Example | 42 | 41.3 | 8 | 4 | 4 | 0.7 | Not | 1.02 | 83.3 | A |
| 16-4 | | | | | | | added | | | |
| Example | 42 | 41.3 | 8 | 4 | 4 | 0.7 | Not | 1.02 | 83.3 | A |
| 16-5 | | | | | | | added | | | |
| Example | 42 | 41.3 | 8 | 4 | 4 | 0.7 | Not | 1.02 | 83.3 | A |
| 16-6 | | | | | | | added | | | |
| Example | 42 | 41.3 | 8 | 4 | 4 | 0.7 | Not | 1.02 | 83.3 | A |
| 16-7 | | | | | | | added | | | |
| Example | 42 | 41.3 | 10 | 2 | 4 | 0.7 | Not | 1.02 | 83.3 | AC |
| 17-1 | | | | | | | added | | | |

TABLE 10

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 400 | 288 | 0.03 | 253 | 20 | 1727 | 137 | Example |
| 12-1 | | | | | | | | of the |
| | | | | | | | | invention |
| Example | 450 | 288 | 0.03 | 329 | 26 | — | — | Example |
| 12-2 | | | | | | | | of the |
| | | | | | | | | invention |
| Example | 520 | 1 | 0.00 | 242 | 19 | — | — | Example |
| 12-3 | | | | | | | | of the |
| | | | | | | | | invention |
| Example | 400 | 288 | 0.03 | 136 | 11 | 1922 | 153 | Example |
| 13-1 | | | | | | | | of the |
| | | | | | | | | invention |
| Example | 450 | 288 | 0.02 | 391 | 31 | — | — | Example |
| 13-2 | | | | | | | | of the |
| | | | | | | | | invention |
| Example | 520 | 1 | 0.02 | 166 | 13 | — | — | Example |
| 13-3 | | | | | | | | of the |
| | | | | | | | | invention |
| Example | 400 | 288 | 0.03 | 399 | 32 | 2254 | 179 | Example |
| 14-1 | | | | | | | | of the |
| | | | | | | | | invention |
| Example | 450 | 288 | 0.02 | 480 | 38 | — | — | Example |
| 14-2 | | | | | | | | of the |
| | | | | | | | | invention |
| Example | 540 | 0.5 | 0.02 | 586 | 47 | 1280 | 102 | Example |
| 14-3 | | | | | | | | of the |
| | | | | | | | | invention |
| Example | 540 | 1 | 0.02 | 202 | 16 | 1491 | 119 | Example |
| 14-4 | | | | | | | | of the |
| | | | | | | | | invention |
| Example | 400 | 288 | 0 | 655 | 52 | 2428 | 193 | Example |
| 15-1 | | | | | | | | of the |
| | | | | | | | | invention |
| Example | 450 | 288 | 0.01 | 521 | 41 | — | — | Example |
| 15-2 | | | | | | | | of the |
| | | | | | | | | invention |
| Example | 500 | 1 | 0.00 | 697 | 55 | 1830 | 146 | Example |
| 15-3 | | | | | | | | of the |
| | | | | | | | | invention |
| Example | 400 | 24 | 0.04 | 471 | 37 | — | — | Example |
| 16-1 | | | | | | | | of the |
| | | | | | | | | invention |
| Example | 400 | 120 | 0 | 659 | 52 | — | — | Example |
| 16-2 | | | | | | | | of the |
| | | | | | | | | invention |
| Example | 400 | 288 | 0.01 | 716 | 57 | 3030 | 241 | Example |
| 16-3 | | | | | | | | of the |
| | | | | | | | | invention |
| Example | 450 | 120 | 0 | 558 | 44 | 2417 | 192 | Example |
| 16-4 | | | | | | | | of the |
| | | | | | | | | invention |
| Example | 450 | 288 | 0 | 537 | 43 | 2176 | 173 | Example |
| 16-5 | | | | | | | | of the |
| | | | | | | | | invention |
| Example | 500 | 1 | 0 | 511 | 41 | — | — | Example |
| 16-6 | | | | | | | | of the |
| | | | | | | | | invention |
| Example | 520 | 1 | 0 | 487 | 39 | — | — | Example |
| 16-7 | | | | | | | | of the |
| | | | | | | | | invention |
| Example | 500 | 1 | 0 | 385 | 31 | 1627 | 129 | Example |
| 17-1 | | | | | | | | of the |
| | | | | | | | | invention |

TABLE 11

| | | | | | | | | | | Result |
|---|---|---|---|---|---|---|---|---|---|---|
| | | | | | | | | | | of |
| | | | | | | | | | | X-ray |
| | | | | | | | | | | diffrac- |
| | | | | | | | | | Mag- | tion |
| | | | | | | | | | netic | (before |
| | | | | | | | | | ele- | heat |
| | Composition (at. %) | | | | | | | Fe/ | ment | treat- |
| | Fe | Ni | Si | B | P | Cu | C | Ni | ratio | ment) |
| Example | 42 | 41.3 | 8 | 8 | Not | 0.7 | Not | 1.02 | 83.3 | A |
| 18-1 | | | | | added | | added | | | |
| Example | 42 | 41.3 | 8 | 8 | Not | 0.7 | Not | 1.02 | 83.3 | A |
| 18-2 | | | | | added | | added | | | |
| Example | 42 | 41.3 | 8 | 6 | 2 | 0.7 | Not | 1.02 | 83.3 | A |
| 19-1 | | | | | | | added | | | |
| Example | 42 | 41.3 | 8 | 6 | 2 | 0.7 | Not | 1.02 | 83.3 | A |
| 19-2 | | | | | | | added | | | |
| Example | 42.6 | 42.6 | 2 | 6 | 4 | 0.7 | Not | 1.00 | 85.2 | AA |
| 20-1 | | | | | | | added | | | |
| Example | 42.6 | 42.6 | 2 | 6 | 4 | 0.7 | Not | 1.00 | 85.2 | AA |
| 20-2 | | | | | | | added | | | |
| Example | 42.6 | 42.6 | 2 | 6 | 4 | 0.7 | Not | 1.00 | 85.2 | AA |
| 20-3 | | | | | | | added | | | |

TABLE 12

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 520 | 1 | 0.03 | 193 | 15 | — | — | Example |
| 18-1 | | | | | | | | of the |
| | | | | | | | | invention |
| Example | 540 | 1 | 0.02 | 214 | 17 | 2054 | 163 | Example |
| 18-2 | | | | | | | | of the |
| | | | | | | | | invention |
| Example | 520 | 1 | 0.02 | 428 | 34 | — | — | Example |
| 19-1 | | | | | | | | of the |
| | | | | | | | | invention |
| Example | 540 | 1 | 0.03 | 479 | 38 | 2656 | 211 | Example |
| 19-2 | | | | | | | | of the |
| | | | | | | | | invention |
| Example | 400 | 288 | 0 | 247 | 20 | — | — | Example |
| 20-1 | | | | | | | | of the |
| | | | | | | | | invention |
| Example | 450 | 288 | 0 | 461 | 37 | — | — | Example |
| 20-2 | | | | | | | | of the |
| | | | | | | | | invention |
| Example | 500 | 1 | 0 | 164 | 13 | — | — | Example |
| 20-3 | | | | | | | | of the |
| | | | | | | | | invention |

TABLE 13

| | | | | | | | | | | Result of |
|---|---|---|---|---|---|---|---|---|---|---|
| | | | | | | | | | | X-ray |
| | | | | | | | | | | diffraction |
| | | | | | | | | | Magnetic | (before |
| | Composition (at. %) | | | | | | | | element | heat |
| | Fe | Ni | Si | B | P | Cu | C | Fe/Ni | ratio | treatment) |
| Example | 42.174 | 42.174 | 0.495 | 9.405 | 3.96 | 0.792 | 1 | 1.00 | 84.348 | A |
| 21-1 | | | | | | | | | | |
| Example | 42.174 | 42.174 | 0.495 | 9.405 | 3.96 | 0.792 | 1 | 1.00 | 84.348 | A |
| 21-2 | | | | | | | | | | |
| Example | 42.174 | 42.174 | 0.495 | 9.405 | 3.96 | 0.792 | 1 | 1.00 | 84.348 | A |
| 21-3 | | | | | | | | | | |
| Example | 42.174 | 42.174 | 0.495 | 9.405 | 3.96 | 0.792 | 1 | 1.00 | 84.348 | A |
| 21-4 | | | | | | | | | | |
| Example | 42.174 | 42.174 | 0.495 | 9.405 | 3.96 | 0.792 | 1 | 1.00 | 84.348 | A |
| 21-5 | | | | | | | | | | |
| Example | 42.174 | 42.174 | 0.495 | 9.405 | 3.96 | 0.792 | 1 | 1.00 | 84.348 | A |
| 21-6 | | | | | | | | | | |
| Example | 42.174 | 42.174 | 0.495 | 9.405 | 3.96 | 0.792 | 1 | 1.00 | 84.348 | A |
| 21-7 | | | | | | | | | | |
| Example | 42.174 | 42.174 | 0.495 | 9.405 | 3.96 | 0.792 | 1 | 1.00 | 84.348 | A |
| 21-8 | | | | | | | | | | |
| Example | 42.174 | 42.174 | 0.495 | 9.405 | 3.96 | 0.792 | 1 | 1.00 | 84.348 | A |
| 21-9 | | | | | | | | | | |

TABLE 14

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 380 | 48 | — | 19 | 1.5 | 1652 | 131 | Example |
| 21-1 | | | | | | | | of the |
| | | | | | | | | invention |
| Example | 380 | 144 | — | 21 | 1.7 | — | — | Example |
| 21-2 | | | | | | | | of the |
| | | | | | | | | invention |
| Example | 380 | 240 | — | 78 | 6.2 | 1854 | 148 | Example |
| 21-3 | | | | | | | | of the |
| | | | | | | | | invention |
| Example | 380 | 720 | — | 9 | 0.7 | — | — | Example |
| 21-4 | | | | | | | | of the |
| | | | | | | | | invention |
| Example | 440 | 10 min | — | 21 | 1.7 | — | — | Example |
| 21-5 | | | | | | | | of the |
| | | | | | | | | invention |
| Example | 460 | 10 min | — | 254 | 20 | — | — | Example |
| 21-6 | | | | | | | | of the |
| | | | | | | | | invention |
| Example | 480 | 10 min | — | 287 | 23 | 1654 | 132 | Example |
| 21-7 | | | | | | | | of the |
| | | | | | | | | invention |
| Example | 500 | 10 min | — | 320 | 25 | — | — | Example |
| 21-8 | | | | | | | | of the |
| | | | | | | | | invention |
| Example | 540 | 10 min | — | 474 | 38 | — | — | Example |
| 21-9 | | | | | | | | of the |
| | | | | | | | | invention |

TABLE 15

| | | | | | | | | | | Result of |
|---|---|---|---|---|---|---|---|---|---|---|
| | | | | | | | | | | X-ray |
| | | | | | | | | | | diffraction |
| | | | | | | | | | Magnetic | (before |
| | Composition (at. %) | | | | | | | | element | heat |
| | Fe | Ni | Si | B | P | Cu | C | Fe/Ni | ratio | treatment) |
| Example | 42 | 41.3 | Not | 16.7 | Not | Not | Not | 1.02 | 83.3 | AM |
| 22-1 | | | added | | added | added | added | | | |
| Example | 42 | 41.3 | Not | 16 | Not | 0.7 | Not | 1.02 | 83.3 | AM |
| 23-1 | | | added | | added | | added | | | |
| Example | 40 | 40 | Not | 2 | 10 | Not | 8 | 1.00 | 80 | A |
| 24-1 | | | added | | | added | | | | |
| Example | 40 | 40 | Not | 2 | 10 | Not | 8 | 1.00 | 80 | A |
| 24-2 | | | added | | | added | | | | |

TABLE 16

| | | | Result of | | | | | |
|---|---|---|---|---|---|---|---|---|
| | | | X-ray | | | | | |
| | Heat treatment | | diffraction | Coercivity | | Remanent | | |
| | Temperature | Time | (after heat | Hc | | coercivity Hcr | | |
| | (° C.) | (h) | treatment) | (Oe) | (kA/m) | (Oe) | (kA/m) | Note |
| Example | 500 | 1 | 0 | 203 | 16 | 1223 | 97 | Example |
| 22-1 | | | | | | | | of the |
| | | | | | | | | invention |
| Example | 500 | 1 | 0 | 194 | 15 | 942 | 75 | Example |
| 23-1 | | | | | | | | of the |
| | | | | | | | | invention |
| Example | 520 | 1 | 0 | 595 | 47 | — | — | Example |
| 24-1 | | | | | | | | of the |
| | | | | | | | | invention |
| Example | 540 | 1 | 0 | 484 | 39 | — | — | Example |
| 24-2 | | | | | | | | of the |
| | | | | | | | | invention |

The remanent coercivity Hcr is measured through applying an external magnetic field to a measurement object while gradually increasing the maximum intensity of the external magnetic field. The intensity of the external magnetic field varies in the opposite direction to the direction of the magnetization of the measurement object. Accordingly, the remanent coercivity Hcr represents the coercivity of a part that is most strongly magnetized in the measurement object. When the ribbon material (FeNi alloy composition) after heat treatment includes an L1₀-type FeNi ordered phase, the L1₀-type FeNi ordered phase is more strongly magnetized than other parts of the FeNi alloy composition. It can therefore be considered that, when the FeNi alloy composition includes an L1₀-type FeNi ordered phase, the remanent coercivity Hcr of the FeNi alloy composition represents the coercivity of the L1₀-type FeNi ordered phase included in the FeNi alloy composition. That is, it is believed that whether or not the FeNi alloy composition includes an L1₀-type FeNi ordered phase can be determined in a simplified manner in accordance with the remanent coercivity Hcr, and when a determination is made that the FeNi alloy composition includes an L1₀-type FeNi ordered phase, qualitative or quantitative information on the L1₀-type FeNi ordered phase can be obtained from the value of the remanent coercivity Hcr. For example, in the FeNi alloy composition according to Example 3-3, the intensity of peak L1₀ cannot be calculated from the X-ray diffraction analysis, but the remanent coercivity Hcr is 1.9×10⁵ A/m, which is a sufficiently high value. Therefore, it has been determined that the FeNi alloy composition according to Example 3-3 includes an L1₀-type FeNi ordered phase.

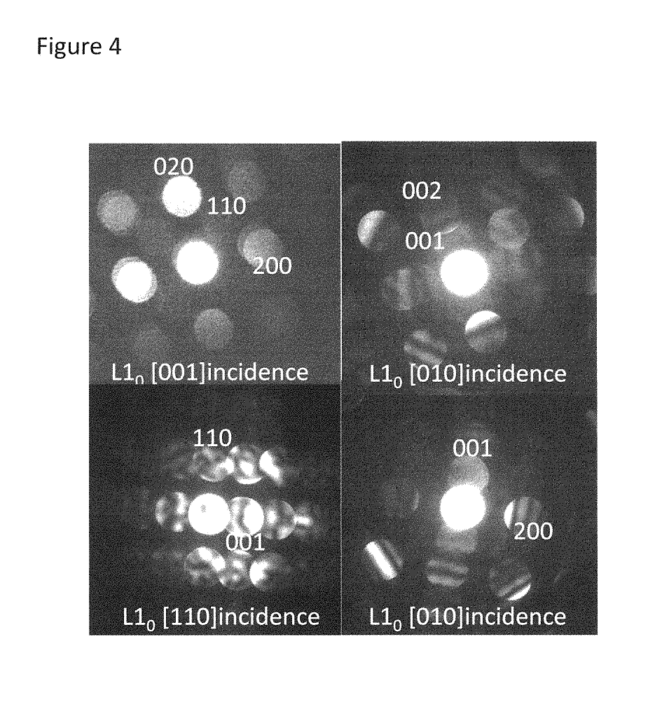

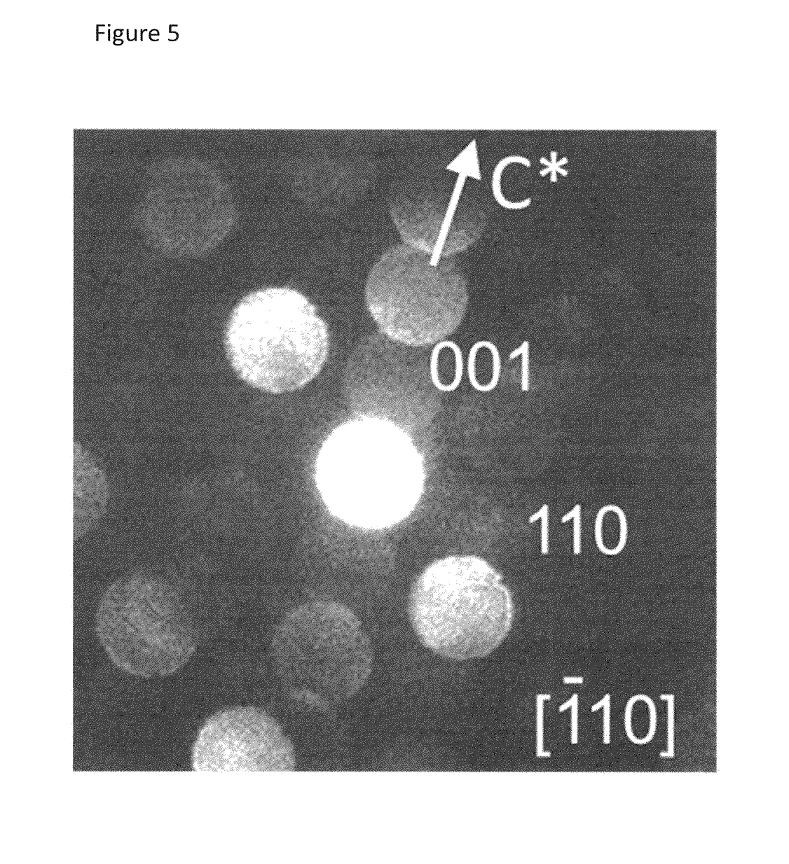

As for the FeNi alloy compositions according to Examples 14-4, 15-3, and 16-3, the crystal structure was observed using a transmission electron microscope (TEM), and the existence of an L1₀-type FeNi ordered phase in these FeNi alloy compositions was directly observed. FIG. 4 shows the observation results of Example 14-4 and FIG. 5 shows the observation result of Example 15-3. The FeNi alloy composition according to Example 16-3 is equal to the FeNi alloy composition which has been evaluated in detail in Example 1 as previously described, so the observation result of Example 16-3 is a part of the result shown in FIG. 2.

### Example 25

Ribbon materials having the composition of Example 16 (see Table 17) were subjected to heat treatment for crystallization (288° C., 1 hour) and then to additional heat treatment as listed in Table 18, and measurement of X-ray diffraction spectra and evaluation of magnetic properties were performed for the FeNi alloy compositions (ribbon materials) after the above two-stage heat treatment. In the measurement of magnetic properties, the saturated magnetization Ms (unit: emu/g) was also measured. Results are listed in Table 18.

TABLE 17

| | | | | | | | | | Result of | | |
|---|---|---|---|---|---|---|---|---|---|---|---|
| | | | | | | | | | X-ray | | |
| | | | | | | | | | diffraction | | |
| | | | | | | | | Magnetic | (before | Heat treatment | |
| | Composition (at. %) | | | | | | | element | heat | Temperature | Time |
| | Fe | Ni | Si | B | P | Cu | Fe/Ni | ratio | treatment) | (° C.) | (h) |
| Example | 42 | 41.3 | 8 | 4 | 4 | 0.7 | 1.02 | 83.3 | A | 400 | 288 |
| 16-3 | | | | | | | | | | | |
| Example | 42 | 41.3 | 8 | 4 | 4 | 0.7 | 1.02 | 83.3 | A | 400 | 288 |
| 25-1 | | | | | | | | | | | |
| Example | 42 | 41.3 | 8 | 4 | 4 | 0.7 | 1.02 | 83.3 | A | 400 | 288 |
| 25-2 | | | | | | | | | | | |
| Example | 42 | 41.3 | 8 | 4 | 4 | 0.7 | 1.02 | 83.3 | A | 400 | 288 |
| 25-3 | | | | | | | | | | | |
| Example | 42 | 41.3 | 8 | 4 | 4 | 0.7 | 1.02 | 83.3 | A | 400 | 288 |
| 25-4 | | | | | | | | | | | |
| Example | 42 | 41.3 | 8 | 4 | 4 | 0.7 | 1.02 | 83.3 | A | 400 | 288 |
| 25-5 | | | | | | | | | | | |
| Example | 42 | 41.3 | 8 | 4 | 4 | 0.7 | 1.02 | 83.3 | A | 400 | 288 |
| 25-6 | | | | | | | | | | | |

TABLE 18

| | | | Result of | | | | | | |
|---|---|---|---|---|---|---|---|---|---|
| | | | X-ray | | | | | | |
| | | | diffraction | | | | | | |
| | Additional heat | | (after | | | | | | |
| | treatment | | additional | | | Saturated | Remanent | | |
| | Temperature | Time | heat | Coercivity Hc | | magnetization | coercivity Hcr | | |
| | (° C.) | (h) | treatment) | (Oe) | (kA/m) | (emu/g) | (Oe) | (kA/m) | Note |
| Example | None | | 0.01 | 716 | 57 | 95 | 3030 | 241 | Example |
| 16-3 | | | | | | | | | of the |
| | | | | | | | | | invention |
| Example | 350 | 1 | 0.01 | 678 | 54 | 97 | 1852 | 147 | Example |
| 25-1 | | | | | | | | | of the |
| | | | | | | | | | invention |
| Example | 450 | 1 | 0.01 | 597 | 48 | 91 | 1852 | 147 | Example |
| 25-2 | | | | | | | | | of the |
| | | | | | | | | | invention |
| Example | 500 | 1 | 0.05 | 424 | 34 | 76 | 1456 | 116 | Example |
| 25-3 | | | | | | | | | of the |
| | | | | | | | | | invention |
| Example | 550 | 1 | 0.03 | 354 | 28 | 73 | 1542 | 123 | Example |
| 25-4 | | | | | | | | | of the |
| | | | | | | | | | invention |
| Example | 600 | 1 | — | 146 | 12 | — | 1203 | 96 | Example |
| 25-5 | | | | | | | | | of the |
| | | | | | | | | | invention |
| Example | 650 | 1 | — | 174 | 14 | — | 1184 | 94 | Example |
| 25-6 | | | | | | | | | of the |
| | | | | | | | | | invention |

As listed in Table 18, the remanent coercivity Hcr deteriorates as the heating temperature increases in the condition of the additional heat treatment, and when the temperature for the additional heat treatment is 600° C. or higher, the remanent coercivity Hcr is less than 1×10⁵ A/m. It is possible that this temperature range is above the ordered phase-disordered phase transformation temperature of the L1₀-type FeNi ordered phase included in the FeNi alloy composition.

Objects of some aspects of the present invention include providing an FeNi alloy composition comprising an L1₀-type FeNi ordered phase using a non-equilibrium process that utilizes nano-crystallization from an alloy as a precursor comprising an amorphous main phase as disclosed in Non-Patent Literature 10, 11. Objects of some aspects of the present invention also include providing a method of manufacturing an FeNi alloy composition comprising an L1₀-type FeNi ordered phase, providing an FeNi alloy composition comprising an amorphous main phase and capable of generating an FeNi alloy composition comprising an L1₀-type FeNi ordered phase, providing a magnetic material that contains the above FeNi alloy composition comprising an L1₀-type FeNi ordered phase, providing a magnetic material that contains an FeNi alloy composition comprising an L1₀-type FeNi ordered phase manufactured through the method of manufacturing an FeNi alloy composition comprising an L1₀-type FeNi ordered phase, and providing a magnetic material that contains an FeNi alloy composition comprising an L1₀-type FeNi ordered phase generated from the above FeNi alloy composition comprising an amorphous main phase.

Some aspects of the present invention provided for the above objects are as follows.

<1> An FeNi alloy composition comprising an L1₀-type FeNi ordered phase, characterized by being manufactured through a method of manufacturing that comprises rapidly melt-quenching an alloy melt comprising Fe and Ni to produce a solid comprising an amorphous main phase, and crystallizing the obtained solid comprising an amorphous main phase.

<2> The FeNi alloy composition comprising an L1₀-type FeNi ordered phase as described in the above <1>, wherein the crystallization temperature of the solid comprising an amorphous main phase is 300° C. or higher and 500° C. or lower, and the heating temperature for crystallizing the solid comprising an amorphous main phase is 300° C. or higher and 500° C. or lower.

<3> The FeNi alloy composition comprising an L1₀-type FeNi ordered phase as described in the above <1> or <2>, wherein the sum of the content of Fe and the content of Ni is 65 at. % or more and 90 at. % or less.

<4> The FeNi alloy composition comprising an L1₀-type FeNi ordered phase as described in any one of the above <1> to <3>, wherein the ratio of the content of Fe to the content of Ni is 0.6 or more and 1.5 or less.

<5> The FeNi alloy composition comprising an L1₀-type FeNi ordered phase as described in any one of the above <1> to <4>, wherein the FeNi alloy composition contains an amorphization element and a crystallization element.

<6> The FeNi alloy composition comprising an L1₀-type FeNi ordered phase as described in any one of the above <1> to <5>, wherein the FeNi alloy composition contains α-Fe.

<7> The FeNi alloy composition comprising an L1₀-type FeNi ordered phase as described in any one of the above <1> to <6>, wherein the FeNi alloy composition contains an Fe rich phase and a Ni rich phase.

<8> A method of manufacturing an FeNi alloy composition comprising an L1₀-type FeNi ordered phase, the method being characterized by comprising: a solidification step of rapidly melt-quenching an alloy melt to produce a solid comprising an amorphous main phase, the alloy melt comprising Fe and Ni; and a heat treatment step of heating and crystallizing the solid comprising an amorphous main phase to form an FeNi alloy composition comprising an L1₀-type FeNi ordered phase, the solid comprising an amorphous main phase being obtained through the solidification step.

<9> The method of manufacturing an FeNi alloy composition comprising an L1₀-type FeNi ordered phase as described in the above <8>, wherein the solid comprising an amorphous main phase obtained through the solidification step has a crystallization temperature of 300° C. or higher and 500° C. or lower, and a heating temperature in the heat treatment step is 300° C. or higher and 500° C. or lower.

<10> The method of manufacturing an FeNi alloy composition comprising an L1₀-type FeNi ordered phase as described in the above <8> or <9>, wherein a mother alloy giving the alloy melt comprising Fe and Ni comprises an amorphization element and a crystallization element.

<11> The method of manufacturing an FeNi alloy composition comprising an L1₀-type FeNi ordered phase as described in any one of the above <8> to <10>, wherein, in a mother alloy giving the alloy melt comprising Fe and Ni, the sum of an additive amount of Fe and an additive amount of Ni is 65 at. % or more and 90 at. % or less.

<12> The method of manufacturing an FeNi alloy composition comprising an L1₀-type FeNi ordered phase as described in any one of the above <8> to <11>, wherein, in a mother alloy giving the alloy melt comprising Fe and Ni, the ratio of an additive amount of Fe to an additive amount of Ni is 0.6 or more and 1.5 or less.

<13> An FeNi alloy composition comprising an amorphous main phase and capable of generating an FeNi alloy composition comprising an L1₀-type FeNi ordered phase, wherein the sum of the content of Fe and the content of Ni is 65 at. % or more and 90 at. % or less, and the FeNi alloy composition comprises an amorphization element and a crystallization element.

<14> The FeNi alloy composition comprising an amorphous main phase as described in the above <13>, wherein the FeNi alloy composition has a crystallization temperature of 300° C. or higher and 500° C. or lower.

<15> A magnetic material containing the FeNi alloy composition comprising an L1₀-type FeNi ordered phase as described in any one of the above <1> to <7>.

<16> A magnetic material containing an FeNi alloy composition comprising an L1₀-type FeNi ordered phase, the FeNi alloy composition being manufactured through the method of manufacturing as described in any one of the above <8> or <12>.

<17> A magnetic material containing an FeNi alloy composition comprising an L1₀-type FeNi ordered phase, the FeNi alloy composition being generated from the FeNi alloy composition comprising an amorphous main phase as described in the above <13> or <14>.

According to the present invention, there is provided an FeNi alloy composition comprising an L1₀-type FeNi ordered phase using a non-equilibrium process that utilizes nano-crystallization from an alloy as a precursor comprising an amorphous main phase. According to the present invention, there are also provided a method of manufacturing an FeNi alloy composition comprising an L1₀-type FeNi ordered phase, an FeNi alloy composition comprising an amorphous main phase and capable of generating an FeNi alloy composition comprising an L1₀-type FeNi ordered phase, a magnetic material that contains the above FeNi alloy composition comprising an L1₀-type FeNi ordered phase, a magnetic material that contains an FeNi alloy composition comprising an L1₀-type FeNi ordered phase manufactured through the method of manufacturing an FeNi alloy composition comprising an L1₀-type FeNi ordered phase, and a magnetic material that contains an FeNi alloy composition comprising an L1₀-type FeNi ordered phase generated from the above FeNi alloy composition comprising an amorphous main phase.

### INDUSTRIAL APPLICABILITY

The FeNi alloy composition comprising an L1₀-type FeNi ordered phase according to the present invention is completely free from rare-earth and is an innovative hard magnetic material for the next generation because of the unique characteristics including high productivity in mass production. Thus, the present invention can contribute to solution of resource problems which the human society of the 21st century faces with.

1. An FeNi alloy composition comprising an L1₀-type FeNi ordered phase,
wherein a sum of a content of Fe and a content of Ni is 90 at. % or less.

2. The FeNi alloy composition comprising an L1₀-type FeNi ordered phase as recited in claim 1, wherein the FeNi alloy composition contains an amorphization element.

3. The FeNi alloy composition comprising an L1₀-type FeNi ordered phase as recited in claim 2, wherein the amorphization element comprises one or more selected from the group consisting of Si, B, and P.

4. The FeNi alloy composition comprising an L1₀-type FeNi ordered phase as recited in claim 2, wherein a sum of a content of the amorphization element is 35 at. % or less.

5. The FeNi alloy composition comprising an L1₀-type FeNi ordered phase as recited in claim 1, wherein a ratio of a content of Fe to a content of Ni is 0.3 or more and 5 or less.

6. The FeNi alloy composition comprising an L1₀-type FeNi ordered phase as recited in claim 1, wherein the FeNi alloy composition further comprises a crystallization element.

7. The FeNi alloy composition comprising an L1₀-type FeNi ordered phase as recited in claim 1, wherein the FeNi alloy composition further contains one or more selected from the group consisting of Cu, Co, Ti, Zr, Hf, V, Nb, Ta, Cr, Mo, W, Mn, Re, platinum group elements, Au, Ag, Zn, In, Sn, As, Sb, Bi, S, Y, N, O, C, and rare-earth elements.

8. The FeNi alloy composition comprising an L1₀-type FeNi ordered phase as recited in claim 1, wherein the FeNi alloy composition is free from a component originated from a meteorite.

9. The FeNi alloy composition comprising an L1₀-type FeNi ordered phase as recited in claim 1, wherein the FeNi alloy composition has a part of which a long-range order (LRO) parameter S is 0.65 or more, wherein the LRO parameter S is calculated based on a measurement result when a nano-beam electron diffraction (NBD) pattern of the L1₀-type FeNi ordered phase is measured.

10. The FeNi alloy composition comprising an L1₀-type FeNi ordered phase as recited in claim 1, wherein the FeNi alloy composition has remanent coercivity Hcr of 1×10⁵ A/m or more.
